(19) United States
(12) Patent Application Publication
(10) Pub. No.: US 2026/0311691 A1
(43) Pub. Date: Oct. 8, 2026

(54) SYSTEMS AND METHODS FOR PROSODIC CLASSIFICATION AND DICTIONARY GENERATION IN SPEECH SIGNALS

(71) Applicant: YEDA RESEARCH AND DEVELOPMENT CO. LTD., Rehovot (IL)

(72) Inventors: Elisha MOSES, Rehovot (IL); Dominik FRENCHE, Rehovot (IL); Nadav MATALON, Rehovot (IL); Eyal WEINREB, Rehovot (IL); Erez VOLK, Rehovot (IL); Tirza BIRON, Rehovot (IL)

(73) Assignee: YEDA RESEARCH AND DEVELOPMENT CO. LTD., Rehovot (IL)

(21) Appl. No.: 19/639,214

(22) Filed: Apr. 5, 2026

(30) Foreign Application Priority Data
Apr. 6, 2025 (IL) 320120

(51) Int. Cl. G10L 15/18; G10L 15/04; G10L 15/06; G10L 25/90

(52) U.S. Cl. CPC G10L 15/1807; G10L 15/063; G10L 25/90; G10L 15/04; G10L 2015/0633

(57) ABSTRACT

A system and computer implemented methods for recognizing at least one of: prosodic-type and at least one prosodic-meaning, for a segment of an audio signal; the method comprising a step of: applying a trained recognizing module on a representative vector, which is configured to represent the segment of the audio signal, to obtain an output of at least one of: prosodic-type and at least one prosodic-meaning; thereby recognizing at least one of: the prosodic-type and the prosodic-meaning/s of the segment of an audio signal.

### CROSS REFERENCE TO RELATED APPLICATIONS

This application claims the benefit of Israeli Patent Application No. 320120 filed on Apr. 6, 2025, which is incorporated in its entirety herein by reference.

### BACKGROUND OF THE INVENTION

Prosody is the musical aspect of speech, including quantifiable vocal features of pitch, loudness, timing, and voice quality. Prosody conveys information on multiple levels parallel to the text, which is essential for human communication. It serves as a means for chunking the flow of speech and emphasizing or de-emphasizing elements within these chunks. It contributes to the formation of conversational actions and enables the expression of various attitudes and emotions. There is a long felt need for a practical tool and methods thereof for extracting information from prosody in speech.

### SUMMARY OF THE INVENTION

According to some embodiments of the invention, a new computer implemented method is provided, for recognizing a prosodic-type and/or at least one prosodic-meaning for an Intonation Unit (IU) audio-signal, the method comprising a step of:
applying a trained recognizing module on an IU vector, configured to represent the IU audio-signal, to obtain an output of a prosodic-type and/or at least one prosodic-meaning; thereby recognizing the prosodic-type and/or the prosodic-meaning/s of the IU audio-signal.

According to some embodiments, the recognizing module comprises: a trained opting module, configured to:
receive an input comprising the IU vector, and
output a prosodic-type for the IU vector, which is selected for being a closest prosodic-type to the IU vector, out of a group of predetermined prosodic-types; and wherein at least one of the following holds true:
   each of the prosodic-types is associated with at least one prosodic-meaning;
   each of the prosodic-types is represented by a prosodic-pattern, and wherein the recognizing module is further configured to output the representative prosodic-pattern of the selected prosodic-type.

According to some embodiments, the trained opting module is trained via clustering, and the predetermined prosodic-types are predetermined prosodic-clusters.

According to some embodiments, the method further comprising a step of:
training the opting module, using a group of training IU vectors representing a group of training IU audio-signals, to cluster the training IU vectors and provide the predetermined clusters, and further provide for each predetermined cluster its representative prosodic-pattern, calculated from its member IU vectors.

According to some embodiments, the training of the opting module is unsupervised.

According to some embodiments, the recognizing module further comprises: a trained associating module, configured to:
receive an input comprising the selected prosodic-type, from the group of predetermined prosodic-types, and
output the prosodic-meaning/s, selected from a group of predetermined prosodic-meanings.

According to some embodiments, the method further comprising a step of:
training the associating module to associate each of the predetermined prosodic-types with at least one prosodic-meaning, selected from the group of predetermined prosodic-meanings, using a 2^{nd} training-set comprising:
   the group of predetermined prosodic-types and their representative prosodic-patterns; and
   per each predetermined prosodic-type a group of its member IU vectors, and their represented IU audio-signals.

According to some embodiments, the step of training the associating module is supervised, and wherein the 2^{nd} training-set further comprises known prosodic-meaning/s and/or extracted text, for at least some of the IU audio-signals of the member IU vectors, in each of the predetermined prosodic-types.

According to some embodiments, the 2^{nd} training set further comprises:
known prosodic-meaning/s and/or extracted text for at least some of the IU audio signals preceding and/or following the member-IU-audio-signals in the source speech.

According to some embodiments, the known prosodic-meaning/s are provided via at least one of:
a linguist interpretation;
adverbial dialog tags in a source speech of the IU audio signals; and
a use of a large language model (LLM); and
any combination thereof.

According to some embodiments, the training of the associating module further comprises:
for each type, calculating a measure of pitch dynamics of its representative prosodic pattern, to quantitatively estimate prosodic markedness of each of the predetermined types.

According to some embodiments, the method further comprises a step of:
determining at least one IU vector, for at least one IU audio-signal, extracted from a source speech.

According to some embodiments, the method further comprising a step of:
segmenting the source speech into a group of IU audio-signals.

According to some embodiments, the segmenting is based on a transcribed source speech.

According to some embodiments, the method further comprising a step of:
treating the IU audio-signal/s, prior to the step of determining of its/their representing IU vectors.

According to some embodiments, the step of treating comprises:
relating each of the extracted IU audio-signals to one of several duration-groups, according to its duration;
and wherein the opting module is trained via training IU vectors representing IU audio-signals related to a single duration-group;
and wherein the opting module is configured to be applied only on IU vectors that represent IU audio-signals related to the single duration-group.

According to some embodiments, the step of determining the IU vector is according- and in relation with-only IU audio-signals that are related to same duration-group.

According to some embodiments, the step of determining is provided via reducing dimensions of the IU audio-signal/s.

According to some embodiments, the step of determining is provided via a trained Autoencoder, and wherein the Autoencoder's input vector and the Autoencoder's output vector comprise the IU audio-signal and/or treated version/s thereof, and wherein the determined IU vector comprises the values of the latent layer of the trained Autoencoder, for the IU audio-signal and/or treated version/s thereof.

According to some embodiments, the treating of the IU audio-signal comprises:
extracting data comprising at least one of: pitch, speech-rate, and intensity.

According to some embodiments, the treating of the IU audio-signal comprises:
re-sampling the extracted data according to a predetermined number of samples, selected for the duration-group of the IU audio-signal.

According to some embodiments, the Autoencoder's input vector and the Autoencoder's output vector are the re-sampled extracted data and/or further treated versions thereof.

According to some embodiments, the prosodic-meaning comprises at least one feature selected from:
attitude, which is at least one selected from: acquiescent, aroused, authoritative, calm, contrary, decisive, disengaged, dissatisfied, dramatic, engaged, enthusiastic, inquisitive, interested, intrigued, knowledgeable, misinformed, mundane, opinionated, passive, puzzled, routine, surprised, unenthusiastic, unknowing, and any combination thereof, and
function, which is at least one selected from: acknowledgement, affiliative/enthusiastic continuer, affirmation/agreement, agreeing second assessment, animated newsmark, astonished repair initiation, basis for combative statement, big-chunk logical conjunction, complaint, conclusive remark, continuer, contrary to previous, contrastive question, contrastive statement, critical statement, dramatic statement, expression of empathy, expression of excitement, expression of mild surprise, expression of surprise, filler/placeholder, frame shift, hesitant transition to predication, initiating dispreferred response, intensification/emphasis, list item, logical conjunction, mocking reported speech/behavior, newsmark, parenthesis, presenting new topic, presenting reported speech, reasserting given information, recycled move, reluctant agreement, repair initiation, response to bad/sad news, rough estimation, strong agreement, strong assessment, surprised newsmark, surprised question, surprising/unexpected statement, transition to predication, try marking (upspeak), weighty acknowledgement, yes-no question, and any combination thereof.

According to some embodiments, the method is implemented via a system comprising at least one of: a processor; memory; one or more code sets comprising instructions for performing the method, the code sets being stored in a memory and executed in a processor; a microphone, an input device, an output device, a display device, and any combination thereof.

According to some embodiments of the invention, a new computer implemented method is provided, for providing a dictionary, and according to some embodiments a prosodic dictionary, for Intonation Unit (IU) audio-signals, the method comprising a step of:
determining a representative IU vector for each of the IU audio-signals;
applying a classifying-module configured to classify the determined IU vectors into a set of prosodic-types;
representing each of the prosodic-types via a prosodic-pattern; and
associating each of the prosodic-types with at least one prosodic-meaning.

According to some embodiments, each of the prosodic-patterns is determined by its member IU vectors.

According to some embodiments, the prosodic dictionary is configured to receive an input of an IU audio-signal and output at least one of:
a prosodic-type for the input IU audio-signal;
a prosodic-pattern for a prosodic-type for the input IU audio-signal;
a prosodic-meaning for the input IU audio-signal; and
any combination thereof.

According to some embodiments, the method further comprising using the prosodic dictionary for at least one of:
automated analysis of speech content;
identification and/or generation of emotional speech;
building prosodic dictionaries for other languages;
comparative analysis of speech across cultural contexts;
comparative analysis of speech across social and/or institutional settings;
characterizing prosodic structure in specific social and/or institutional settings;
prosodic guidance for improved performance specific social and/or institutional settings;
diagnosis of the effect of aging on speech;
evaluation of development stages during (typical or atypical) language acquisition;
evaluation of the naturality of LLM speech outputs;
classification of discourse types (e.g., narrative, argumentative) by prosodic structure;
identification of commercial and/or sponsored content in social media;
identification and/or filtering of abusive content in social media; and
any combination thereof.

According to some embodiments, the prosodic dictionary is further configured to store and update at least one of:
a set of predetermined prosodic-types;
a relative frequency of each prosodic-type;
a typical context of occurrence of each prosodic-type;
an emotional content for each of the prosodic-type;
an attitude that each prosodic-type is characteristic of;
functions that each prosodic-type can fulfil; and
any combination thereof.

According to some embodiments, the method is implemented via a system comprising at least one of: a processor; memory; one or more code sets comprising instructions for performing the method, the code sets being stored in a memory and executed in a processor; a microphone, an input device, an output device, a display device, and any combination thereof.

According to some embodiments of the invention, a new computer implemented method is provided, for recognizing a prosodic-type and/or at least one prosodic-meaning for a segment of an audio signal, the method comprising a step of:
applying a trained recognizing module on a representative vector, which is configured to represent the segment of the audio signal, to obtain an output of a prosodic-type and/or at least one prosodic-meaning;
thereby recognizing the prosodic-type and/or the prosodic-meaning/s of the segment of an audio signal.

According to some embodiments, the segment of the audio signal is one selected from: a word, a sentence, an intonation unit, a syllable, interpausal unit, speaker turn and any combination thereof.

According to some embodiments, the recognizing module comprises: a trained opting module, configured to:
receive an input comprising the representative vector, and
output a prosodic-type for the representative vector, which is selected for being a closest prosodic-type to the representative vector, out of a group of predetermined prosodic-types; and wherein at least one of the following holds true:
   each of the prosodic-types is associated with at least one prosodic-meaning;
   each of the prosodic-types is represented by a prosodic-pattern, and wherein the recognizing module is further configured to output the representative prosodic-pattern of the selected prosodic-type.

According to some embodiments, the trained opting module is trained via clustering, and the predetermined prosodic-types are predetermined prosodic-clusters.

According to some embodiments, the method further comprising a step of:
training the opting module, using a group of training representative vectors representing a group of training segments of audio-signals, to cluster the training representative vectors and provide the predetermined clusters, and further provide for each predetermined cluster its representative prosodic-pattern, calculated from its member representative vectors.

According to some embodiments, the training of the opting module is unsupervised.

According to some embodiments, the recognizing module further comprises: a trained associating module, configured to:
receive an input comprising the selected prosodic-type, from the group of predetermined prosodic-types, and
output the prosodic-meaning/s, selected from a group of predetermined prosodic-meanings.

According to some embodiments, the method further comprising a step of:
training the associating module to associate each of the predetermined prosodic-types with at least one prosodic-meaning, selected from the group of predetermined prosodic-meanings, using a 2^{nd} training-set comprising:
   the group of predetermined prosodic-types and their representative prosodic-patterns; and
   per each predetermined prosodic-type a group of its member representative vectors, and their represented segments of audio-signals.

According to some embodiments, the step of training the associating module is supervised, and wherein the 2^{nd} training-set further comprises known prosodic-meaning/s and/or extracted text, for at least some of the segments of audio-signals of the member representative vectors, in each of the predetermined prosodic-types.

According to some embodiments, the 2^{nd} training set further comprises:
known prosodic-meaning/s and/or extracted text for at least some of the segments of audio signals preceding and/or following the member-representative-audio-signals in the source speech.

According to some embodiments, the known prosodic-meaning/s are provided via at least one of:
a linguist interpretation;
adverbial dialog tags in a source speech of the representative audio signals; and
a use of a large language model (LLM); and
any combination thereof.

According to some embodiments, the training of the associating module further comprises:
for each type, calculating a measure of pitch dynamics of its representative prosodic pattern, to quantitatively estimate prosodic markedness of each of the predetermined types.

According to some embodiments, the method is implemented via a system comprising at least one of: a processor; memory; one or more code sets comprising instructions for performing the method, the code sets being stored in a memory and executed in a processor, a microphone, an input device, an output device, a display device and any combination thereof.

According to some embodiments of the invention, a new computer implemented method is provided, for providing a dictionary, and according to some embodiments a prosodic dictionary, for segments of audio signals, the method comprising a step of:
determining a representative vector for each of the segments of the audio signals; according to some embodiments, by extracting at least one acoustic feature selected from pitch, intensity, and speech-rate from each segment;
applying a classifying-module configured to classify the determined representative vector into a predetermined number of prosodic-types;
representing each of the prosodic-types via a prosodic-pattern; and
associating each of the prosodic-types with at least one prosodic-meaning.

According to some embodiments, the segment of the audio signal is one selected from: a word, a sentence, an intonation unit, a syllable, interpausal unit, speaker turn and any combination thereof.

According to some embodiments, each of the prosodic-patterns is determined by its member representative vector.

According to some embodiments, the prosodic dictionary is configured to receive an input of a segment of an audio signal and output at least one of:
a prosodic-type for the input segment of an audio signal;
a prosodic-pattern for a prosodic-type for the input segment of an audio signal;
a prosodic-meaning for the input segment of an audio signal; and
any combination thereof.

According to some embodiments, the method further comprising using the prosodic dictionary for at least one of:
automated analysis of speech content;
identification and/or generation of emotional speech;
building prosodic dictionaries for other languages;
comparative analysis of speech across cultural contexts;
comparative analysis of speech across social and/or institutional settings;
characterizing prosodic structure in specific social and/or institutional settings;
prosodic guidance for improved performance specific social and/or institutional settings;
diagnosis of the effect of aging on speech;
evaluation of development stages during (typical or atypical) language acquisition;
evaluation of the naturality of LLM speech outputs;
classification of discourse types (e.g., narrative, argumentative) by prosodic structure;
identification of commercial and/or sponsored content in social media;
identification and/or filtering of abusive content in social media; and
any combination thereof.

According to some embodiments, the prosodic dictionary is further configured to store and update at least one of:
a set of predetermined prosodic-types;
a relative frequency of each prosodic-type;
a typical context of occurrence of each prosodic-type;
an emotional content for each of the prosodic-type;
an attitude that each prosodic-type is characteristic of;
functions that each prosodic-type fulfil; and
any combination thereof.

According to some embodiments, the method is implemented via a system comprising at least one of: a processor, memory; one or more code sets comprising instructions for performing the method, the code sets being stored in a memory and executed in a processor; a microphone, an input device, an output device, a display device and any combination thereof.

According to some embodiments of the invention, a new computer implemented method is provided for recognizing at least one of: prosodic-type and at least one prosodic-meaning for a segment of an audio signal; the method comprising:
determining, by at least one processor, a representative vector for the segment of the audio signal, by extracting at least one acoustic feature selected from: pitch, intensity, and speech-rate from the segment;
applying a trained recognizing module on the representative vector to obtain an output of at least one of: prosodic-type and at least one prosodic-meaning;
thereby recognizing at least one of: the prosodic-type and the prosodic-meaning for the segment of the audio signal.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 demonstrates a computer implemented method for recognizing a prosodic-type and/or at least one prosodic-meaning for an Intonation Unit (IU) audio-signal, according to some embodiments of the invention;

FIG. 2 demonstrates a computer implemented method for recognizing a prosodic-type and/or at least one prosodic-meaning for a segment of an audio signal, according to some embodiments of the invention;

FIGS. 3A, 3B, 3C and 3D demonstrate an example of clustering IUs, according to some embodiments of the invention; FIG. 3A demonstrates a block diagram of the clustering process, according to some embodiments of the invention; FIG. 3B demonstrates the distribution of the sizes of clusters in three spontaneous speech datasets, as a ratio of population size, according to some embodiments of the invention; FIG. 3C demonstrates the fraction of “real” and “noise” clusters in the first and repeated clustering cycles (CH dataset), according to some embodiments of the invention; FIG. 3D demonstrates the distribution of four categories: “correct prosody”, “incorrect prosody” (IUs not adhering to the cluster's prosodic pattern), “segmentation error”, and “FO extraction error”, within 20 clusters (n=3484 IUs, CH dataset);

FIGS. 4A, 4B and 4C demonstrate clusters and linguistic function, according to some embodiments of the invention; FIG. 4A demonstrates a summary of the functions and attitudes for 20 clusters, each bar represents a cluster, with the x-axis indicating the fraction of IUs exhibiting recurring functions; the stacked bars represent the frequencies of the functions in the cluster; Function numbers correspond to Table 5 attitudes associated with each cluster are distinguished by hues and specified on the right; FIG. 4B demonstrates eight IUs consisting only of the word ‘yeah’, taken from four different clusters and exhibiting prosodic form-function relations (attitudes marked by hues matching those in panel 2a, functions specified above); the overlay (right) demonstrates the differences between the clusters; it is noted that the presented pitch contours are not speaker normalized (0 semitones=100 Hz; CH dataset); FIG. 4C demonstrates a representative sample of IUs, from cluster c4_6095 with varying text, accomplishing three distinct functions and sharing one attitude“—enthusiastic”; the overlay (right) demonstrates the common form of the IUs within the cluster.; it is noted that the presented pitch contours are not speaker normalized (0 semitones=100 Hz; CH dataset);

FIG. 5A, 5B and 5C demonstrate cluster pairs and linguistic function, according to some embodiments of the invention; FIG. 5A demonstrates Fraction of IU pairs sharing a recurring function in 34 cluster pairs (horizontal dashed line marks the 50% threshold of “functional uniformity”). FIGS. 5B and 5C demonstrate text and pitch trace of two representative instances of cluster pair, c9_16027-c6_10137, as in FIG. 5B, and cluster pair c1_1042-c6_10069, as in FIG. 5C; the vertical dashed lines in FIGS. 5B and 5C represent boundaries between IUs;

FIG. 6A, 6B, 6C, 6D and 6E demonstrate cluster pair analysis, according to some embodiments of the invention; FIGS. 6A and 6B demonstrate abundance of cluster pairs in real data, compared to random sequences, in the CH (FIG. 6A) and in SBC (FIG. 6B) datasets (semi-log); FIGS. 6C and 6D demonstrate absolute differences between the number of occurrences of cluster pairs and of their reverse pairs in real data compared to random sequences, in the CH (FIG. 6C) and SBC (FIG. 6D) datasets (semi-log); the error bars in FIGS. 6A-6D are shown for the random distributions; FIG. 6E demonstrates earth mover's distance (EMD) between real data and 100 random permutations in three data types; each “violin” shows the median (white dot), interquartile range (dark box), min to max spread (dark line), and the estimated probability density of the data (a single density curve around the centerline rather than the baseline).

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following detailed description, at least some embodiments of the invention comprise analysis and/or processing of speech signals and/or audio signals and methods thereof. According to some embodiments, signals are processed in a digital representation, such that speech/audio processing and/or analysis can be regarded as a case of digital signal processing, applied to said speech/audio signals. According to some embodiments, aspects of said speech/audio processing and/or analysis comprise at least one of: acquisition, manipulation, storage, transfer, output of signals and any combination thereof. According to some embodiments, different speech/audio processing and/or analysis task comprise at least one of: recognition, synthesis, digitization, enhancement, recognition, and any combination thereof.

According to some embodiments, pitch refers to a measured and/or determined auditory impression of speech sounds, as located on a scale between “high” and “low”. Physiologically, it is primarily dependent on the rate of vibration of the vocal cords within the larynx. The three prosodic features of pitch are intonation, which refers generally to speech melody, key (alternatively span), which refers to the pitch range of a given intonation contour and register, which refers to the contour's overall highness or lowness.

According to some embodiments, pitch contour refers to a function or curve that tracks the perceived pitch of the speech sound over time.

According to some embodiments, fundamental frequency and/or (FO) refer to a measured and/or determined acoustic correlate of pitch. Fundamental frequency (FO) is defined as the lowest frequency of a periodic waveform.

According to some embodiments, register refers to the overall measured and/or determined highness or lowness of a pitch contour. A pitch contour's register is measured within the voice range of the particular speaker producing the pitch contour.

According to some embodiments, loudness refers to a measured and/or determined auditory correlate of intensity, i.e., the amount of energy which is present in a sound or sequence of sounds. It is realized through associating relative prominence to single syllables or when raising the voice over longer stretches of talk.

According to some embodiments, voice quality refers to a measured and/or determined quality of voice determined by settings of the mouth and tongue (supralaryngeal) and settings involving the vocal cords or the larynx as a whole (laryngeal), resulting in different phonation types. Common prosodically relevant voice qualities are creaky voice, breathy voice and whispery voice.

According to some embodiments, linguistic function refers to the interactional meaning of an utterance within its given context of use, at the level of illocutionary force, i.e., at the level of the conversational action (for example, question, statement, agreement, acknowledgement, complaint, and the like) that the utterance is performing, or taking part in performing.

According to some embodiments, speech data set refers to a collection of speech data. A speech data set includes audio files containing recordings of speech. It may also include textual data with transcription of the recorded speech data. It may also include tabular data with information about the recorded speech and/or the people that produced the recorded speech.

According to some embodiments, large language model (LLM) refers to a type of machine learning model designed for natural language processing tasks such as language generation. LLMs are language models with many parameters, and are trained with self-supervised learning on a vast amount of text.

According to some embodiments, clustering refers to the task of grouping a set of objects in such a way that objects in the same group (called a cluster) are more similar to each other (in some specific sense) than to those in other groups (clusters).

According to some embodiments, intonation refers to a measured and/or determined variation in pitch, used to indicate the speaker's attitudes and emotions, to highlight or focus an expression, to signal the illocutionary act performed by a sentence, and/or to regulate the flow of discourse. For example, the English question “Does Joe speak Spanish or French?” is interpreted as a yes-or-no question when it is uttered with a single rising intonation contour, but is interpreted as an alternative question when uttered with a rising contour on “Spanish” and a falling contour on “French”. Although intonation is primarily a matter of pitch variation, its effects almost always work hand-in-hand with other prosodic features. Intonation is distinct from tone, the phenomenon where pitch is used to distinguish words or to mark grammatical features.

According to some embodiments, prosody refers to the musical facet of speech, and is pivotal in human communication. Herein, and according to some embodiments of the invention, a data-driven model and methods thereof are provided for English prosody analysis, based on large-scale analysis of spontaneous conversations. Approximately 200 discernible prosodic patterns were identified as building blocks of the prosodic vocabulary- and their properties and range of meanings were outlined. Next, according to some embodiments, a Markovian logic is provided, akin to a syntax, for concatenating these elementary building blocks into coherent utterances. Distinct compound functions were identified and associated with pairs of consecutive patterns, and the Markovian syntax is shown to be more prevalent in spontaneous prosody, as compared to scripted speech. These results offer invaluable insights into the underlying mechanisms of conversational prosody: they empirically inform and refine existing theoretical concepts. The presented novel methodology, combining unsupervised analysis of large datasets of spontaneous speech with manual sampling of the results, is configured to guide future research and/or models aimed at refining the provided model and expanding it to other languages.

According to some embodiments, dictionary refers to a reference source, containing entries, for example a list of words, with information given for each entry; for example for each word, usually including meaning and pronunciation; the information for each word can also include: its etymology, translation in other languages, frequency of occurrence, typical examples and context of use, and places of occurrence in specific texts.

According to some embodiments, prosodic dictionary refers to a reference source containing a list of prosodic-types, with information given for each of the prosodic-types. The information for each prosodic-type can include at least one of: a representative prosodic pattern; associated meaning/s, including but not limited to, linguistic functions; the speaker's attitude and/or emotional content; frequency of occurrence; typical examples and context of use thereof; places of occurrence in specific speech datasets; and any combination thereof.

In conversation, prosody complements words, forming a structured communication system distinct from, yet connected to, text. According to some embodiments, by analyzing large datasets of spontaneous conversations and clustering similar snippets of speech, the currently provided model identifies the fundamental building blocks of this system. According to some embodiments, the currently provided model provides a prosodic vocabulary of a few hundred patterns (far fewer than the thousands of words in a core verbal vocabulary), which fulfill interactional and attitudinal functions. Just as syntax governs word combinations, the model is configured to observe recurring prosodic structures, where certain patterns follow others more frequently than chance. The model's results provide data-driven support for an analogy of prosody to a linguistic system with its own vocabulary, semantics, and a simple syntax.

According to some embodiments, a data-driven approach is provided, and prosody is examined as a linguistic system, in its own right, as though it were an unknown language. According to some embodiments, a large volume of conversational English is explored, configured to move away from controlled stimuli towards natural data. According to some embodiments, the conversational data is compared to scripted speech to be configured to identify distinct features of spontaneous prosody.

According to some embodiments, the methods described herein comprise an analysis of parsing Intonation Units (IUs), referred herein as the primary prosodic unit of spoken discourse. According to some embodiments, each IU is a snippet of speech that typically consists of 1-4 words (compared to about 15-20 words per typical written sentence). It is prosodically coherent and well-delimited, temporally structured, and considered a universal characteristic of speech. IU boundaries are characterized by prosodic cues such as pitch, intensity and speech rate. Modulations of the rate are considered the most reliable cues for IU boundaries and are used here for automatic parsing of IUs.

A conversation thus consists of a string of IUs and each IU is associated with a specific string of words. When stripped of the text, each IU consists of a pitch contour. This pitch variation over a time can be viewed as a particular instance of an element of the prosodic vocabulary. Accordingly, there is a need for identifying such a vocabulary in conversational English.

Current approaches to identify a prosodic vocabulary are “top-down”: they assume that a finite-state grammar that uses a predetermined set of basic constituents generates IU-sized pitch contours. The basic constituents occupy specific locations within the IU, thus creating its inner structure. Estimates of the vocabulary size are combinatorial and range from 10-20 commonly used meaningful contours to over 1,000 “well-formed” contours.

According to some embodiments, each IU in the database is represented by a vector combining pitch and intensity. These vectors are encoded in a latent space and then grouped by unsupervised clustering. According to some embodiments, the centroid of each cluster is a pitch contour that represents a single building block, and the set of all building blocks is the prosodic vocabulary. Thus, according to some embodiments a vocabulary is built using a bottom-up approach without assuming a predefined collection of the structural components that constitute an IU.

Clustering of pitch contours was previously attempted for speech synthesis, for validating predefined intonation categories, to explore prosody in indigenous languages, and to enhance computer understanding of speech. Accordingly, there is a need for a first large-scale unsupervised analysis of prosodic patterns in spontaneous conversation and the first data-driven attempt to describe prosody in conversational English.

Ideally, clustering of pitch contours would result in homogenous and well-separated groups, representing the prosodic patterns in the data. However, such clusters were previously shown to be imperfect, with significant overlap in the relevant space. Ambiguous clustering partly results from unavoidable noise in naturalistic recordings. In addition, the boundaries between prosodic categories are inherently fuzzy, and a given IU may present features characteristic of more than one cluster. Accordingly, there is a need for a clustering approach that would be qualitatively correct but quantitatively approximate, offering order-of-magnitude estimates of cluster numbers and sizes, not precise measurements.

Nevertheless, an approximate prosodic vocabulary suffices to ask: Are there rules for combining these elements? Can they, or their combinations, convey linguistic meaning? The possibility to concatenate IUs to form meaningful sequences has been previously proposed. Accordingly, there is a need for analysis of full conversations with minimal filtering (elaborated in the Methods section) that empirically explores recurring prosodic patterns.

The meaning of prosodic elements has been previously investigated. Some theoreticians focus on the conveyance of emotion or attitude. Others disregard emotive meaning and highlight prosody's part in fulfilling text-related functions, such as signaling information status and propositional relationships. Such assertions often rely on introspection and on specific, at times contrived, examples. Accordingly, there is a need to examine the functions of prosody empirically, with no prior assumptions regarding their nature.

According to some embodiments, two key findings are currently provided: first, spontaneously produced IUs cluster meaningfully without considering their associated text. It is estimated that 200 (within a factor of 2) distinct prosodic patterns are prevalent in conversational English. According to some embodiments, a typical cluster's prosodic pattern can serve various context-dependent linguistic functions and conveys a broader attitudinal meaning. These results support identifying a finite vocabulary of IU-sized prosodic patterns in a language.

Second, pairs of specific clusters—i.e., an IU from one cluster immediately followed in conversation by an IU from a second cluster—occur significantly more frequently than expected by chance. Often, such pairs serve a specific linguistic function. This result does not extend to triplets or longer sequences. It suggests that a syntax-like combinatorial system governs IU-sized prosodic pattern order, largely following a Markovian process where each pattern depends on the preceding one. Taken together, the currently provided investigation methods provide a first data-driven approximation for the prosodic vocabulary and syntax in conversational English.

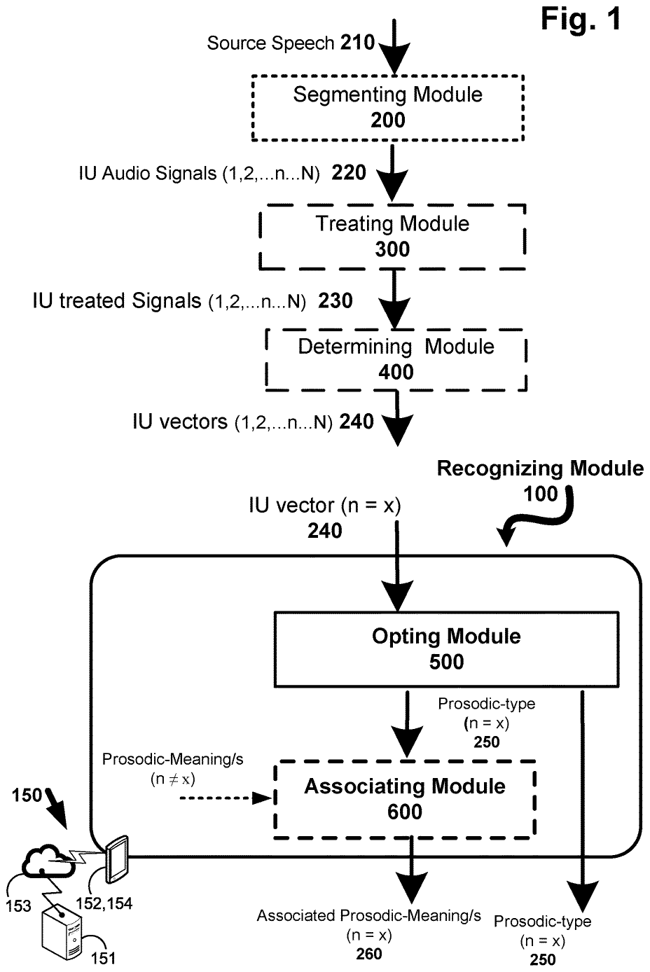

According to some embodiments of the invention, and as demonstrated for example in FIG. 1, a computer implemented method is provided, for recognizing a prosodic-type and/or at least one prosodic-meaning for an Intonation Unit (IU) audio-signal (220).

According to some embodiments, the method comprises a step of:
applying a trained recognizing module (100) on an IU vector (240), configured to represent the IU audio-signal (220), to obtain an output of a prosodic-type (250) and/or at least one prosodic-meaning (260);
thereby recognizing the prosodic-type and/or the prosodic-meaning/s of the IU audio-signal.

According to some embodiments, and as demonstrated for example in FIG. 1, the denoted “IU vector (n=x)”, refers to the IU vector that is currently provided to the recognizing module (100), out of a plurality of N IU vectors; and the denoted “Prosodic meaning (n=x)”, refers to the Prosodic-meaning that is associated to the IU vector (n=x), by the recognizing module. According to some embodiments, and as further demonstrated for example in FIG. 1, the denoted “Prosodic-meaning (n+x)”, refers to a prosodic-meaning and/or extracted text that is related to a different IU vector, not the currently provided.

According to some embodiments, the recognizing module comprises: a trained opting module (500), configured to:
receive an input comprising the IU vector, and
output a prosodic-type for the IU vector, which is selected for being a closest prosodic-type to the IU vector, out of a group of predetermined prosodic-types; and wherein at least one of the following holds true:
   each of the prosodic-types is associated with at least one prosodic-meaning;
   each of the prosodic-types is represented by a prosodic-pattern, and wherein the recognizing module is further configured to output the representative prosodic-pattern of the selected prosodic-type.

According to some embodiments, the trained opting module is trained via clustering, and the predetermined prosodic-types are predetermined prosodic-clusters.

According to some embodiments, the method further comprises a step of:
training the opting module, using a group of training IU vectors representing a group of training IU audio-signals, to cluster the training IU vectors and provide the predetermined clusters, and further provide for each predetermined cluster its representative prosodic-pattern, calculated from its member IU vectors.

According to some embodiments, the prosodic-pattern is determined by averaging the type's member IU vectors.

According to some embodiments, the training of the opting module is unsupervised.

According to some embodiments, the recognizing module further comprises: a trained associating module (600), configured to:
receive an input comprising the selected prosodic-type (250), from the group of predetermined prosodic-types, and
output the prosodic-meaning/s, selected from a group of predetermined prosodic-meanings.

According to some embodiments, the method further comprises a step of:
training the associating module to associate each of the predetermined prosodic-types with at least one prosodic-meaning, selected from the group of predetermined prosodic-meanings, using a 2^{nd} training-set comprising:
   the group of predetermined prosodic-types and their representative prosodic-patterns; and
   per each predetermined prosodic-type a group of its member IU vectors, and their represented IU audio-signals.

According to some embodiments, the step of training the associating module is supervised, and wherein the 2^{nd} training-set further comprises known prosodic-meaning/s and/or extracted text, for at least some of the IU audio-signals of the member IU vectors, in each of the predetermined prosodic-types.

According to some embodiments, the 2^{nd} training set further comprises:
known prosodic-meaning/s and/or extracted text for at least some of the IU audio signals preceding and/or following the member-IU-audio-signals in the source speech.

According to some embodiments, the known prosodic-meaning/s are provided via at least one of:
a linguist interpretation;
adverbial dialog tags in a source speech of the IU audio signals; and
a use of a large language model (LLM); and
any combination thereof.

According to some embodiments, the training of the associating module (600) further comprises:
for each type, calculating a measure of pitch dynamics of its representative prosodic pattern, to quantitatively estimate prosodic markedness of each of the predetermined types.

According to some embodiments, the method further comprises a step of:
determining (300,400) at least one IU vector (240), for at least one IU audio-signal (220), extracted from a source speech (210).

According to some embodiments, further comprising a step of:
segmenting (200) the source speech into a group of IU audio-signals (220).

According to some embodiments, the segmenting is based on a transcribed source speech.

According to some embodiments, the method further comprising a step of:
treating (300) the IU audio-signal/s (220), prior to the step of determining (400) of its/their representing IU vectors (240). According to some embodiments, treating comprises any kind of signal processing.

According to some embodiments, the step of treating comprises:
relating each of the extracted IU audio-signals to one of several duration-groups, according to its duration;
and wherein the opting module is trained via training IU vectors representing IU audio-signals related to a single duration-group;
and wherein the opting module is configured to be applied only on IU vectors that represent IU audio-signals related to the single duration-group.

According to such embodiments, the method comprises several opting modules, wherein each opting module is configured to be applied on a different group of IU vectors, according to its associated duration group, as it is trained via training IU vectors representing IU audio-signals related to a single duration-group. Accordingly, each trained opting module selects a type for an IU vector only from the predetermined types that are related to that IU's duration-group.

According to some embodiments, the step of determining the IU vector is according- and in relation with-only IU audio-signals that are related to same duration-group.

According to some embodiments, the step of determining is provided via reducing dimensions of the IU audio-signal/s.

According to some embodiments, the step of determining is provided via a trained Autoencoder, and wherein the Autoencoder's input vector and the Autoencoder's output vector comprise the IU audio-signal and/or treated version/s thereof, and wherein the determined IU vector comprises the values of the latent layer of the trained Autoencoder, for the IU audio-signal and/or treated version/s thereof.

According to some embodiments, the treating of the IU audio-signal comprises:
extracting data comprising at least one of: pitch, speech-rate, and intensity.

According to some embodiments, the treating of the IU audio-signal comprises:
re-sampling the extracted data according to a predetermined number of samples, selected for the duration-group of the IU audio-signal.

According to some embodiments, the Autoencoder's input vector and the Autoencoder's output vector are the re-sampled extracted data and/or further treated versions thereof.

According to some embodiments of the invention, a computer implemented method is provided, for providing a prosodic dictionary for Intonation Unit (IU) audio-signals. According to some embodiments, the method comprises a step of:
determining a representative IU vector for each of the IU audio-signals;
training and/or applying a classifying-module, configured to classify the determined IU vectors into a set of prosodic-types;
representing each of the prosodic-types via a prosodic-pattern; and
associating each of the prosodic-types with at least one prosodic-meaning.

According to some embodiments, each of the prosodic-patterns is determined by its member IU vectors.

According to some embodiments, the prosodic dictionary is configured to receive an input of an IU audio-signal and output at least one of:
a prosodic-type for the input IU audio-signal;
a prosodic-pattern for a prosodic-type for the input IU audio-signal;
a prosodic-meaning for the input IU audio-signal; and
any combination thereof.

According to some embodiments, the method further comprises using the prosodic dictionary for at least one of:
automated analysis of speech content;
identification and/or generation of emotional speech;
building prosodic dictionaries for other languages;
comparative analysis of speech across cultural contexts;
comparative analysis of speech across social and/or institutional settings;
characterizing prosodic structure in specific social and/or institutional settings; such as, but not limited to:
   characterizing prosodic structure in classroom discourse;
   characterizing prosodic structure in courtroom discourse; and
   characterizing prosodic structure in sales calls;
prosodic guidance for improved performance specific social and/or institutional settings; such as, but not limited to:
   prosodic guidance for improved performance in classroom discourse;
   prosodic guidance for improved performance in courtroom discourse; and
   prosodic guidance for improved performance in sales calls;
diagnosis of the effect of aging on speech;
evaluation of development stages during (typical or atypical) language acquisition;
evaluation of the naturality of LLM speech outputs;
classification of discourse types (e.g., narrative, argumentative) by prosodic structure;
identification of commercial and/or sponsored content in social media;
identification and/or filtering of abusive content in social media; and
any combination thereof.

According to some embodiments, the prosodic dictionary is further configured to store and update at least one of:
a set of predetermined prosodic-types;
a relative frequency of each prosodic-type;
a typical context of occurrence of each prosodic-type;
an emotional content for each of the prosodic-type;
an attitude that each prosodic-type is characteristic of;
functions that each prosodic-type can fulfil; and
any combination thereof.

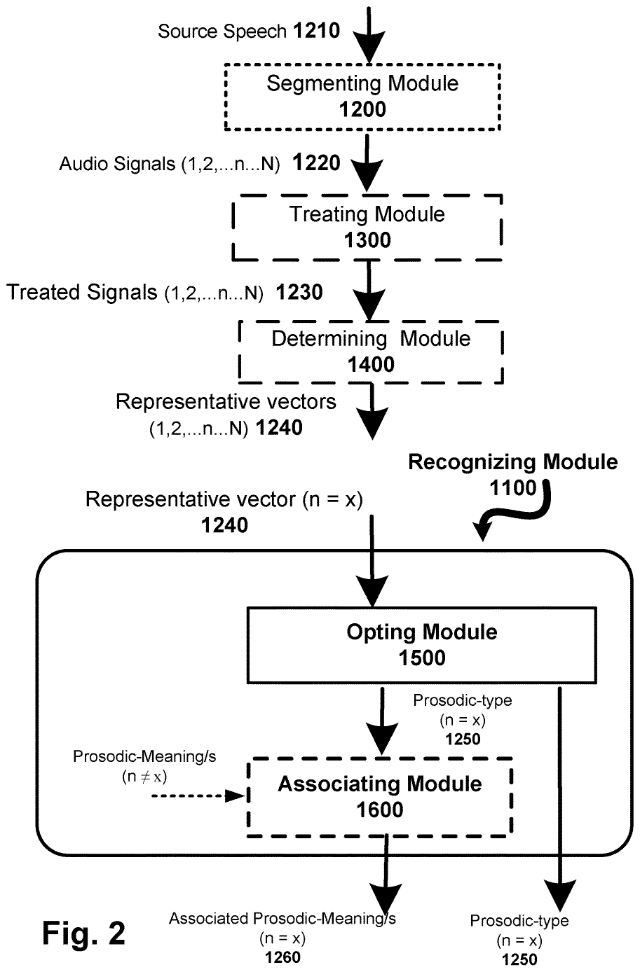

According to some embodiments of the invention, and as demonstrated for example in FIG. 2, a computer implemented method is provided, for recognizing a prosodic-type and/or at least one prosodic-meaning for a segment of an audio signal (1220).

According to some embodiments, the method comprises a step of:
applying a trained recognizing module (1100) on a representative vector (1240), which is configured to represent the segment of the audio signal, to obtain an output of a prosodic-type (1250) and/or at least one prosodic-meaning (1260);
thereby recognizing the prosodic-type and/or the prosodic-meaning/s of the segment of an audio signal.

According to some embodiments, and as demonstrated for example in FIG. 2, the denoted “Representative vector (n=x)”, refers to the representative vector that is currently provided to the recognizing module (1100), out of a plurality of N representative vectors; and the denoted “Prosodic meaning (n=x)”, refers to the Prosodic-meaning that is associated to the representative vector (n=x), by the recognizing module. According to some embodiments, and as further demonstrated for example in FIG. 2, the denoted “Prosodic-meaning (n+x)”, refers to a prosodic-meaning and/or extracted text that is related to a different representative vector, not the currently provided.

According to some embodiments, the segment of the audio signal is one selected from (but not limited to): a word, a sentence, an intonation unit, a syllable, interpausal unit, speaker turn and any combination thereof.

According to some embodiments, the recognizing module comprises: a trained opting module (1500), configured to:
receive an input comprising the representative vector, and
output a prosodic-type for the representative vector, which is selected for being a closest prosodic-type to the representative vector, out of a group of predetermined prosodic-types; and
wherein at least one of the following holds true:
   each of the prosodic-types is associated with at least one prosodic-meaning;
   each of the prosodic-types is represented by a prosodic-pattern, and wherein the recognizing module is further configured to output the representative prosodic-pattern of the selected prosodic-type.

According to some embodiments, the trained opting module is trained via clustering, and the predetermined prosodic-types are predetermined prosodic-clusters.

According to some embodiments, the method further comprises a step of:
training the opting module, using a group of training representative vectors representing a group of training segments of audio-signals, to cluster the training representative vectors and provide the predetermined clusters, and further provide for each predetermined cluster its representative prosodic-pattern, calculated from its member representative vectors.

According to some embodiments, the prosodic-pattern is determined by averaging the type's member representative vectors.

According to some embodiments, the training of the opting module is unsupervised.

According to some embodiments, the recognizing module further comprises: a trained associating module (1600), configured to:
receive an input comprising the selected prosodic-type (1250), from the group of predetermined prosodic-types, and
output the prosodic-meaning/s, selected from a group of predetermined prosodic-meanings.

According to some embodiments, the method further comprises a step of:
training the associating module to associate each of the predetermined prosodic-types with at least one prosodic-meaning, selected from the group of predetermined prosodic-meanings, using a 2^{nd} training-set comprising:
   the group of predetermined prosodic-types and their representative prosodic-patterns; and
   per each predetermined prosodic-type a group of its member representative vectors, and their represented segments of audio-signals.

According to some embodiments, the step of training the associating module is supervised, and wherein the 2^{nd} training-set further comprises known prosodic-meaning/s and/or extracted text, for at least some of the segments of audio-signals of the member representative vectors, in each of the predetermined prosodic-types.

According to some embodiments, the 2^{nd} training set further comprises:
known prosodic-meaning/s and/or extracted text for at least some of the segments of audio signals preceding and/or following the member-representative-audio-signals in the source speech.

According to some embodiments, the known prosodic-meaning/s are provided via at least one of:
a linguist interpretation;
adverbial dialog tags in a source speech of the representative audio signals; and
a use of a large language model (LLM); and
any combination thereof.

According to some embodiments, the training of the associating module (1600) further comprises:
for each type, calculating a measure of pitch dynamics of its representative prosodic pattern, to quantitatively estimate prosodic markedness of each of the predetermined types.

According to some embodiments, the method further comprises a step of:
determining (1300,1400) at least one representative vector (1240), for at least one segment of audio-signal (1220), extracted from a source speech (1210).

According to some embodiments, further comprising a step of:
segmenting (1200) the source speech into a group of segments of audio-signals (1220).

According to some embodiments, the segmenting is based on a transcribed source speech.

According to some embodiments, the method further comprises a step of:
treating (1300) the segment/s of audio-signal/s (1220), prior to the step of determining (1400) of its/their representing representative vectors (1240). According to some embodiments, treating comprises any kind of signal processing.

According to some embodiments, the step of treating comprises:
relating each of the extracted segments of audio-signals to one of several duration-groups, according to its duration;
and wherein the opting module is trained via training representative vectors representing segments of audio-signals related to a single duration-group;
and wherein the opting module is configured to be applied only on representative vectors that represent segments of audio-signals related to the single duration-group.

According to such embodiments, the method comprises several opting modules, wherein each opting module is configured to be applied on a different group of representative vectors, according to its associated duration group, as it is trained via training representative vectors representing segments of audio-signals related to a single duration-group. Accordingly, each trained opting module selects a type for a representative vector only from the predetermined types that are related to that duration-group, namely members.

According to some embodiments, the step of determining the representative vector is according- and in relation with-only segments of audio-signals that are related to same duration-group.

According to some embodiments, the step of determining is provided via reducing dimensions of the segment/s of audio-signal/s.

According to some embodiments, the step of determining is provided via a trained Autoencoder, and wherein the Autoencoder's input vector and the Autoencoder's output vector comprise the segments of audio-signal and/or treated version/s thereof, and wherein the determined representative vector comprises the values of the latent layer of the trained Autoencoder, for the segments of audio-signal and/or treated version/s thereof.

According to some embodiments, the treating of the segments of audio-signal comprises:
extracting data comprising at least one of: pitch, speech-rate, and intensity.

According to some embodiments, the treating of the segments of audio-signal comprises:
re-sampling the extracted data according to a predetermined number of samples, selected for the duration-group of the segment of audio-signal.

According to some embodiments, the Autoencoder's input vector and the Autoencoder's output vector are the re-sampled extracted data and/or further treated versions thereof.

According to some embodiments of the invention, a computer implemented method is provided, for providing a prosodic dictionary for segments of audio signals. According to some embodiments, the method comprises a step of:
determining a representative vector for each of the segments of the audio signals;
training and/or applying a classifying-module, configured to classify the determined representative vector into a predetermined number of prosodic-types;
representing each of the prosodic-types via a prosodic-pattern; and
associating each of the prosodic-types with at least one prosodic-meaning.

According to some embodiments, the segment of the audio signal is one selected from (but not limited to): a word, a sentence, an intonation unit, a syllable, interpausal unit, speaker turn and any combination thereof.

According to some embodiments, each of the prosodic-patterns is determined by its member representative vector.

According to some embodiments, the prosodic dictionary is configured to receive an input of a segment of an audio signal and output at least one of:
a prosodic-type for the input segment of an audio signal;
a prosodic-pattern for a prosodic-type for the input segment of an audio signal;
a prosodic-meaning for the input segment of an audio signal; and
any combination thereof.

According to some embodiments, the method further comprises using the prosodic dictionary for at least one of:
automated analysis of speech content;
identification and/or generation of emotional speech;
building prosodic dictionaries for other languages;
comparative analysis of speech across cultural contexts;
comparative analysis of speech across social and/or institutional settings;
characterizing prosodic structure in specific social and/or institutional settings; such as, but not limited to:
   characterizing prosodic structure in classroom discourse;
   characterizing prosodic structure in courtroom discourse; and
   characterizing prosodic structure in sales calls;
prosodic guidance for improved performance specific social and/or institutional settings; such as, but not limited to:
   prosodic guidance for improved performance in classroom discourse;
   prosodic guidance for improved performance in courtroom discourse; and
   prosodic guidance for improved performance in sales calls;
diagnosis of the effect of aging on speech;
evaluation of development stages during (typical or atypical) language acquisition;
evaluation of the naturality of LLM speech outputs;
classification of discourse types (e.g., narrative, argumentative) by prosodic structure;
identification of commercial and/or sponsored content in social media;
identification and/or filtering of abusive content in social media; and
any combination thereof.

According to some embodiments, the prosodic dictionary is further configured to store and update at least one of:
a set of predetermined prosodic-types;
a relative frequency of each prosodic-type;
a typical context of occurrence of each prosodic-type;
an emotional content for each of the prosodic-types;
an attitude that each prosodic-type is characteristic of;
functions that each prosodic-type can fulfil; and
any combination thereof.

According to some embodiments, the prosodic-meaning comprises at least one feature selected from:
attitude, which is at least one selected from: acquiescent, aroused, authoritative, calm, contrary, decisive, disengaged, dissatisfied, dramatic, engaged, enthusiastic, inquisitive, interested, intrigued, knowledgeable, misinformed, mundane, opinionated, passive, puzzled, routine, surprised, unenthusiastic, unknowing, and any combination thereof; and
function, which is at least one selected from: acknowledgement, affiliative/enthusiastic continuer, affirmation/agreement, agreeing second assessment, animated newsmark, astonished repair initiation, basis for combative statement, big-chunk logical conjunction, complaint, conclusive remark, continuer, contrary to previous, contrastive question, contrastive statement, critical statement, dramatic statement, expression of empathy, expression of excitement, expression of mild surprise, expression of surprise, filler/placeholder, frame shift, hesitant transition to predication, initiating dispreferred response, intensification/emphasis, list item, logical conjunction, mocking reported speech/behavior, newsmark, parenthesis, presenting new topic, presenting reported speech, reasserting given information, recycled move, reluctant agreement, repair initiation, response to bad/sad news, rough estimation, strong agreement, strong assessment, surprised newsmark, surprised question, surprising/unexpected statement, transition to predication, try marking (upspeak), weighty acknowledgement, yes-no question, and any combination thereof.

According to some embodiments of the inventions, any one of the modules mentioned herein comprises at least one of: neural network (NN), machine learning (ML), large language model (LLM), artificial intelligence (AI), big data analysis, manual analysis, linguistic interpretation, signal processing, crowd sourcing, linear programming, statistical analysis, and any combination thereof.

According to some embodiments of the inventions, any one of the methods mentioned herein is implemented via a system (150) comprising at least one of: a processor (151); memory (153); one or more code sets comprising instructions for performing the method, the code sets being stored in a memory and executed in a processor; a microphone, an input device (152), an output device (154), a display device and any combination thereof.

A non-limiting example for system architecture: according to some embodiments, the invention is implemented via a system comprising a plurality of functional modules configured to perform digital signal processing operations on speech audio signals. According to some embodiments, the system comprises one or more of the following components and/or modules, each of which is implemented by software instructions executed by one or more processors, by dedicated hardware, or by a combination thereof.

A segmentation module. According to some embodiments, the segmentation module is configured to receive a source speech signal and to partition the signal into speech segments (such as IU audio-signals) using prosodic-boundary cues, including at least one of: inter-word pauses, local slowing in speech rate, phone-duration changes, a transcription and/or forced alignment.

A feature extraction module. According to some embodiments, the feature extraction module is configured to derive a time sequence of prosodic feature values for each speech segment, including at least one of: pitch, intensity, duration, speech rate, and/or voice-quality measurements.

A normalization and resampling module. According to some embodiments, the normalization and resampling module is configured to transform variable-length feature sequences into fixed-length feature representations suitable for comparison across segments. According to some embodiments, pitch values are converted from Hertz to a semitone scale, speaker-normalized, interpolated, smoothed using intensity-weighted averaging, and resampled to a length associated with a duration group.

An encoder module. According to some embodiments, the encoder module is configured to map a fixed-length feature representation to a lower-dimensional latent vector using a trained autoencoder and/or other dimensionality-reduction model. According to some embodiments, the encoder uses dropout regularization and latent-space regularizers, such as but not limited to Sliced-Wasserstein regularization.

A clustering module. According to some embodiments, the clustering module is configured to group latent vectors into prosodic clusters using unsupervised clustering, such as but not limited to variational Bayesian Gaussian mixture modeling. According to some embodiments, clusters smaller than a threshold population are reprocessed in repeated clustering cycles. According to some embodiments, a representative prosodic pattern is generated for each prosodic cluster.

A meaning association module. According to some embodiments, the meaning association module is configured to associate one or more prosodic meanings with each prosodic cluster using manual annotation, classifier-based association trained on labeled clusters, associated texts, context segments, adverbial dialogue tags, and/or labels produced by a large language model.

A dictionary store. According to some embodiments, the dictionary module is configured to store, for each prosodic-type, a type identifier, representative prosodic-pattern, associated prosodic-meanings, frequency information, example segments, contexts of occurrence, markedness measures, and links to ordered-pair transitions. According to some embodiments, the dictionary is maintained as a machine-readable data structure.

A transition module. According to some embodiments, the transition module is configured to store recurrent ordered pairs of prosodic-types with transition frequencies, reverse-pair asymmetries, compound prosodic meanings, and flags indicating syntax-like relationships. According to some embodiments, the transition model is configured to implement a Markovian structure where a prosodic pattern's occurrence depends mainly on the preceding prosodic-type.

An inference engine. According to some embodiments, the inference engine is configured to apply the trained recognizing module to new speech segments to assign prosodic-types, retrieve representative prosodic-patterns, retrieve prosodic-meanings, and evaluate transition relationships. According to some embodiments, the inference engine operates in batch mode, streaming mode, and/or hybrid mode.

An output interface. According to some embodiments, the output interface is configured to generate and provide machine-readable prosodic annotations including time stamps, segment identifiers, prosodic-type identifiers, meaning labels, confidence values, links to representative prosodic-patterns, and/or transition relationships. According to some embodiments, the annotation is formatted as structured text, tables, JSON objects, database records, and/or token streams aligned with transcripts.

A machine-readable prosodic annotation. According to some embodiments, the system generates a machine-readable prosodic annotation for each processed speech segment. According to some embodiments, the machine-readable prosodic annotation includes one or more of: a time stamp and/or segment identifier, a prosodic-type identifier, one or more prosodic-meaning labels, confidence values, a link to a representative prosodic-pattern, and/or a transition relationship with adjacent segments. According to some embodiments, the annotation is stored as structured text, a table, a graph, a token stream aligned with a transcript, a database record, a JSON object, and/or another machine-readable format. According to some embodiments, the machine-readable prosodic annotation is provided to a downstream automated speech-processing system configured for at least one of speech-content analysis, discourse classification, emotional-speech generation, speech-synthesis evaluation, and/or abusive-content detection.

According to some embodiments, the system operates in batch mode, streaming mode, and/or hybrid mode. In streaming mode, incoming speech is segmented and annotated incrementally, with the transition model updated as additional segments arrive. In batch mode, large corpora is processed offline to generate updated dictionary entries, language-specific statistics, or application-specific meaning associations.

A computing environment. According to some embodiments, the disclosed systems and methods are implemented in a computing environment comprising one or more processors, memory, persistent storage, one or more input devices such as a microphone or network interface, and one or more output devices such as a display or speaker. Memory stores instructions that, when executed by the processors, cause the computing environment to perform one or more of the segmentation, feature extraction, encoding, clustering, dictionary generation, transition modeling, and inference operations described herein. According to some embodiments, the computing environment comprises a computing device, a distributed system, a cloud-based service, and/or a combination thereof.

According to some embodiments of the invention, a new computer-implemented method is provided for processing a source speech signal, the method comprising:
receiving digitized audio corresponding to the source speech signal;
segmenting the digitized audio into a plurality of speech segments;
selecting a target speech segment of the plurality of speech segments;
extracting from the target speech segment a time sequence of prosodic feature values comprising at least pitch values and intensity values;
normalizing and resampling the time sequence of prosodic feature values to generate a fixed-length feature representation for the target speech segment;
encoding, using a trained dimensionality-reduction model, the fixed-length feature representation into a latent vector;
assigning the latent vector to a prosodic cluster of a plurality of stored prosodic clusters based on a similarity measure in a latent space;
retrieving, from memory, a prosodic type associated with the prosodic cluster and at least one of (i) a representative prosodic pattern of the prosodic cluster or (ii) a prosodic meaning associated with the prosodic cluster; and
generating a machine-readable prosodic annotation for the target speech segment, the machine-readable prosodic annotation identifying the prosodic type.

According to some embodiments, the speech segments are intonation units and segmenting the digitized audio comprises identifying segment boundaries based on at least one of: an inter-word pause, a decrease in local speech rate, and/or a transcribed source speech.

According to some embodiments, the prosodic feature values further comprise at least one of speech-rate values, duration values, and/or voice-quality values.

According to some embodiments, normalizing the time sequence comprises converting pitch values from Hertz to a semitone scale and speaker-normalizing the pitch values based on a speaker-specific median pitch.

According to some embodiments, normalizing and resampling the time sequence comprises linearly interpolating undefined pitch values and smoothing the pitch values using an intensity-weighted moving average before resampling to the fixed-length feature representation.

According to some embodiments, the target speech segment is assigned to a duration group, the fixed-length feature representation is generated according to a resampling length associated with the duration group, and the latent vector is assigned only among prosodic clusters associated with the duration group.

According to some embodiments, the trained dimensionality-reduction model comprises an autoencoder and the latent vector comprises values of a latent layer of the autoencoder.

According to some embodiments, the autoencoder is trained using dropout regularization and a latent-space distribution regularizer that constrains latent vectors to a bounded region of the latent space.

According to some embodiments, the stored prosodic clusters are generated by variational Bayesian Gaussian mixture modeling of latent vectors of training speech segments, and wherein training speech segments assigned to clusters below a size threshold are reprocessed in at least one additional clustering cycle.

According to some embodiments, the method further comprising providing the machine-readable prosodic annotation to an automated speech-processing system configured for at least one of speech-content analysis, discourse classification, emotional-speech generation, speech-synthesis evaluation, or abusive-content detection.

According to some embodiments of the invention, a new computer-implemented method is provided for generating a prosodic dictionary from a training corpus of speech signals, the method comprising:
segmenting the training corpus into training speech segments;
generating, for each training speech segment, a fixed-length prosodic feature representation;
encoding the fixed-length prosodic feature representations into corresponding latent vectors;
clustering the latent vectors to obtain a plurality of prosodic clusters;
generating, for each prosodic cluster, a representative prosodic pattern based on member vectors of the prosodic cluster;
associating, for each prosodic cluster, at least one prosodic meaning with the prosodic cluster; and
storing in memory a prosodic dictionary comprising the prosodic clusters, the representative prosodic patterns, and the associated prosodic meanings.

According to some embodiments, clustering is performed separately for a plurality of duration groups of the training speech segments.

According to some embodiments, clustering comprises unsupervised clustering of the latent vectors and repeated re-clustering of latent vectors associated with clusters smaller than a threshold population.

According to some embodiments, associating the at least one prosodic meaning comprises using at least one of: manual annotation, text associated with member speech segments, context speech segments adjacent to member speech segments, adverbial dialogue tags, and/or labels generated by a large language model.

According to some embodiments, the method further comprising calculating, for at least one prosodic cluster, a markedness measure based on pitch dynamics of the representative prosodic pattern and storing the markedness measure in the prosodic dictionary.

According to some embodiments, the method further comprising determining recurrent ordered pairs of prosodic clusters in the training corpus, associating at least one compound prosodic meaning with at least one recurrent ordered pair, and storing transition information for the recurrent ordered pairs in the prosodic dictionary.

According to some embodiments of the invention, a new system is provided for processing speech, comprising:
one or more processors; and
memory storing a prosodic dictionary and instructions that, when executed by the one or more processors, cause the system to:
   receive digitized audio representing a source speech signal;
   segment the source speech signal into speech segments;
   for a selected speech segment, generate a latent vector from prosodic feature values of the selected speech segment;
   assign the latent vector to a stored prosodic cluster;
   retrieve a prosodic type associated with the stored prosodic cluster; and
   output a machine-readable result identifying the prosodic type and at least one of a representative prosodic pattern, a prosodic meaning, or a transition relationship with another prosodic type.

According to some embodiments, the system further comprising at least one of a microphone, a network interface, a storage device, a display, or a speaker.

According to some embodiments, the machine-readable result is used to control at least one of a speech-synthesis engine, a speech-to-text engine, a dialogue-state model, or an automated content-moderation engine.

According to some embodiments, the memory stores a plurality of duration-group-specific models, and the system selects one of the duration-group-specific models according to a duration of the selected speech segment.

A non-limiting example for an algorithm outline, according to some embodiments of the invention:
1. Training
   1.1. Preprocessing
      1.1.1. taking a large corpus of transcribed speech audio signals;
         1.1.1.1. one option—it is pre-transcribed;
         1.1.1.2. alternatively—if it is not pre-transcribed, it is transcribed automatically using existing tools;
      1.1.2. segmenting the audio into IU audio signals;
      1.1.3. IU audio signals are grouped into groups with similar durations;
         1.1.3.1. this can be done by splitting the whole population of IU audio signals into 10 equally-sized groups;
      1.1.4. processing each IU audio signal—resulting in an IU feature vector;
         1.1.4.1. feature vectors can represent one or more features and/or combinations of features;
         1.1.4.1.1. examples of possible features:
         1.1.4.1.1.2. mel-frequency cepstral coefficients;
         1.1.4.1.1.3. intensity;
         1.1.4.1.1.4. speech rate;
         1.1.4.1.1.5. voice quality
         1.1.4.2. one option for the processing workflow:
         1.1.4.2.1. pitch and intensity are taken;
         1.1.4.2.2. convert pitch to semitones;
         1.1.4.2.3. normalize pitch by speaker median;
         1.1.4.2.4. linearly interpolate pitch where missing;
         1.1.4.2.5. smooth pitch with intensity weighted mean, resulting in a feature vector that represents a combination of both pitch and intensity;
         1.1.4.2.6. resample the feature vector to a common length according to the group assigned in 1.1.3;
         1.1.4.3. other options:
         1.1.4.3.1. convert pitch to the bark or mel scales;
         1.1.4.3.2. normalize pitch and/or intensity by speaker mean, range, or standard deviation;
         1.1.4.3.3. non-linear interpolation methods;
         1.1.4.3.4. reduce pitch extraction errors by assuming octave sized fluctuations are incorrect;
         1.1.4.3.5. reduce pitch extraction errors by ignoring pitch samples below a threshold of intensity
1.2. Clustering-done separately for each duration group:
   1.2.1. taking all the IU feature vectors in a group and embedding them into a shared latent space with reduced dimensionality-resulting in IU embedded vectors;
      1.2.1.1. this can be done using an autoencoder that is trained on all the IU feature vectors in the group-resulting in a trained embedding neural network;
         1.2.1.1.1. the sliced-Wasserstein technique can be used in the autoencoder training process to impose a distribution on the IU embedded vectors in the latent space;
         1.2.1.1.1.1. the imposed distribution can be a uniform distribution over a “thick-walled spherical shell”;
         1.2.1.1.2 the autoencoder can also be of the variational type;
      1.2.1.2. alternatively—this can be done using other common dimensionality reduction algorithms;
   1.2.2. taking the many IU embedded vectors in the group together and clustering them in the shared latent space, resulting in clusters;
      1.2.2.1. this can be done using Gaussian mixture model clustering;
      1.2.2.2.alternatively—this can be done using other common clustering algorithms;
      1.2.2.3. additionally, very small clusters can be discarded, improving the quality of the clustering output;
      1.2.2.4. additionally, the IUs members of discarded clusters can be combined, treated as an additional group, re-embedded (as in 1.2.1), and re-clustered (as in 1.2.2) to generate additional clusters;
   1.2.3. alternatively, clustering can be done directly in the feature vector space skipping the embedding step;
   1.2.4. alternatively, dimensionality reduction and/or clustering can be done using a supervised method, where the clusters' members are known;
1.3. Associating, each cluster is associated with one or more prosodic meaning/s (encompassing speaker attitudes and linguistic functions) from a predetermined list; this results in a form-meaning association for each cluster;
   1.3.1. this can be done wholly by manual analysis;
   1.3.2. alternatively—this can be done using a classifier that is trained to infer the associations;
      1.3.2.1. the classifier can be trained on manually-analyzed clusters;
      1.3.2.2. the classifier can be trained on the long context of the speech being analyzed;
      1.3.2.3. the classifier can be trained on ‘adverbial tags’ instances from recorded corpora where meta-text indicates the prosodic meanings. example—“‘You shot me,’ he said incredulously”—George R. R. Martin, A Storm of Swords;
2. Inference
   2.1. speech audio is segmented into IU audio signals;
   2.2. the IU audio signal that one wish to infer is assigned to a group from 1.1.3 according to its duration;
   2.3. the IU audio signal is preprocessed as in 1.1.4 resulting in an IU feature vector;
   2.4. the IU feature vector is embedded in its assigned group's latent space created in 1.2.1 resulting in an IU embedded vector;
      2.4.1. this can be done using the trained embedding neural network from 1.2.1.1;
      2.4.2. alternatively, this can be done using another common dimensionality reduction algorithm as in 1.2.1.2;
   2.5. the IU embedded vector is assigned to one of the clusters created in 1.2.2;
      2.5.1. this can be done by choosing the cluster whose centroid is nearest in the latent space to the IU embedded vector;
      2.5.2. alternatively, this can be done by choosing the cluster consisting of the nearest member in the latent space to the IU embedded vector;
      the IU is thus classified as an instance of the prosodic type of that cluster, and is inferred to possess the prosodic meanings associated with the type of that cluster in 1.3.

### Results

### Clustering Intonation Units Using Pitch and Intensity

Two representative datasets of natural spoken language were analyzed—the CallHome Corpus (CH) (A. Canavan, D. Graff, G. Zipperlen, CALLHOME American English Speech. LDC97S42 (Preprint) (1997)) and the Santa Barbara Corpus (SBC) (J. W. Du Bois, et al., Santa Barbara corpus of spoken American English. (Preprint) (2005))—and three audiobooks representative of scripted speech-CT^{pro}, SOIaF^{pro}, and SOIaF^{amt} (elaborated in the Methods section). The SBC is manually segmented to IUs, and CH and the audiobooks were automatically segmented using the method as reported in (T. Biron, et al., Automatic detection of prosodic boundaries in spontaneous speech. PLOS One 16, e0250969 (2021)).

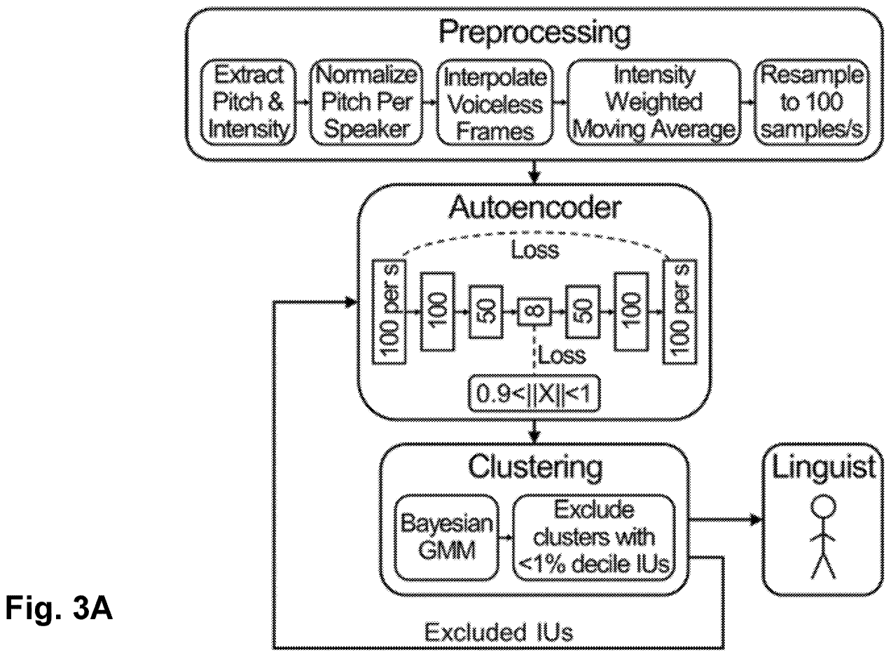

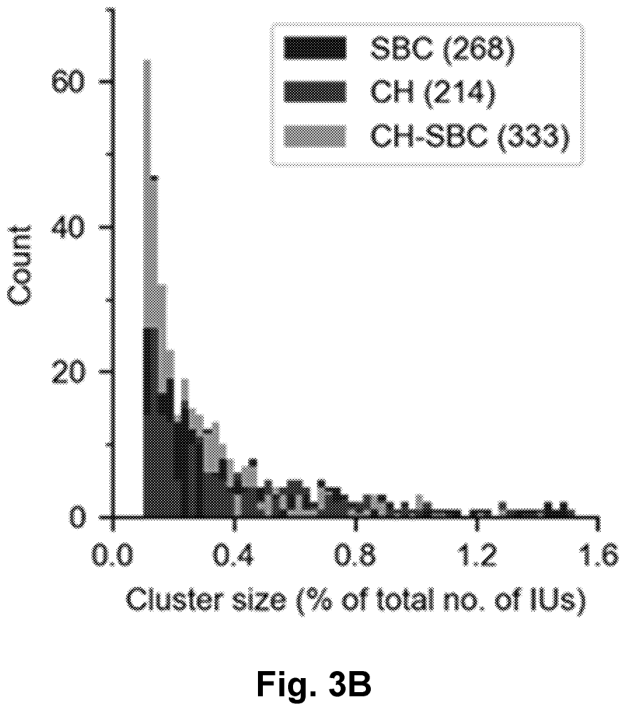

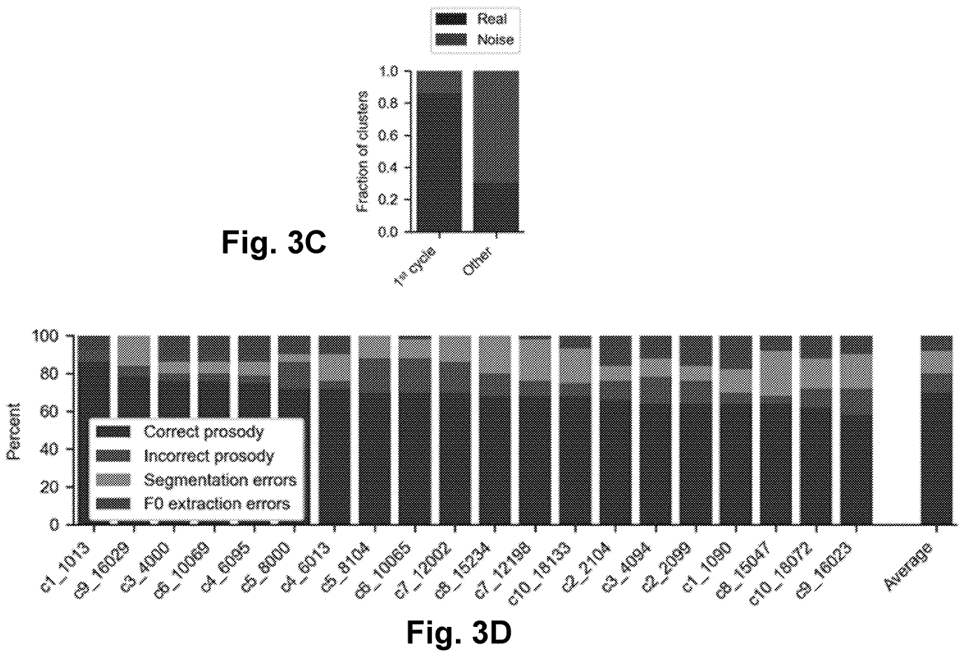

According to some embodiments of the invention, IUs were divided into deciles according to their duration, and each decile was clustered using the algorithm outlined in FIG. 3A. Clusters smaller than 1% of the decile population were discarded, and the corresponding IUs were used in repeated clustering cycles (elaborated in the Methods section). In all datasets, more than 90% of IUs were successfully clustered. The resulting cluster statistics are described in Table 1. As Table 1 shows, the corresponding silhouette scores do not indicate well-separated clusters. Rather, they reflect the gradient transition between prosodic categories. As expected, the prosodic markedness of a given cluster is inversely related to its size. Large clusters reflect the tendency of speakers to maintain relatively constant pitch, within their vocal comfort zone.

TABLE 1
Resulting clusters.

| | Number of | | | | |
|---|---|---|---|---|---|
| | clusters | Cluster | Cluster | | |
| | (first-cycle | size mean | size range | Coverage | Silhouette |
| Dataset | clusters) | (IUs) | (IUs) | (% IUs) | score |
| CH | 214 (168) | 185 | 43-1226 | 91.9 | 0.11 |
| SBC | 268 (189) | 134 | 40-618 | 90.9 | 0.11 |
| CH-SBC | 333 (220) | 229 | 82-2879 | 92.5 | 0.11 |
| CT^{pro} | 216 (160) | 225 | 52-2062 | 92.1 | 0.10 |
| SOIaF^{pro} | 226 (165) | 307 | 74-2731 | 93.4 | 0.10 |
| SOIaF^{amt} | 340 (228) | 162 | 59-1491 | 94.1 | 0.12 |

Spontaneous speech: CH = CallHome Corpus; SBC = Santa Barbara Corpus; CH-SBC combined.
Audiobooks: CT^{pro} = Century Trilogy book No. 3 (professional production); SOIaF^{pro} = A Song of Ice and Fire book No. 5 (professional production); SOIaF^{amt} = A Song of Ice and Fire book No. 5 (amateur production).

FIGS. 3C and 3D describe the clustering results of the main dataset (CH), according to some embodiments of the invention. Out of 43,086 IUs that are eligible for acoustic analysis, 39,612 (91.9%) were successfully clustered: 33,576 (77.9%) in the first clustering cycle, and 6036 (14%) in repeated cycles. A preliminary quality check distinguished between “real clusters” (n=159), depicting genuine prosodic patterns, and “clusters of noise” (n=55), grouping IUs with severe FO (pitch) extraction errors. It was found that, to a great extent, the first-cycle of clustering (n=168) filters out such erroneous IUs, as demonstrated in FIG. 3C.

Next, according to some embodiments of the invention, 20 “real” clusters were randomly sampled, 2 from each decile (n=3484 IUs). Manual examination of this sample revealed that 70%±1 of IUs in a given cluster adhere to a distinct prosodic pattern. The manual analysis included an evaluation of the automatic segmentation and of the extraction of FO. It was found that 12%±1 of IUs in a given cluster involve segmentation errors and 9%±1 contain FO extraction errors, as demonstrated in FIG. 3D (mean±SE). Misclassification of IUs stemmed mostly from these two error types. Thus, the resulting clusters depict identifiable and distinct prosodic patterns.

To address consistency, according to some embodiments two conversational corpora were combined and analyzed as a single dataset. It is noted that first, that doubling dataset size did not double the number of resulting clusters, nor did it change the overall distribution of cluster sizes (as demonstrated in Table 1 and FIG. 3B). It was found that 35%±1 of the IUs found in a given cluster in one of the original datasets ended up in the same cluster in the joined dataset. A total of 60%±1 of the IUs found in a given cluster in one of the original datasets were found in three clusters from the joined dataset (mean±SE).

Finally, according to some embodiments, when the clustering hyperparameters and algorithm were varied, the numbers of resulting clusters did not substantially change. In addition, since the clustering process involves inherent randomness, the process was repeated 100 times with fixed hyperparameter values and obtained consistent cluster-size distributions.

### Clusters of IUs Exhibit Functional Polysemy and Share a Broad Linguistic Meaning

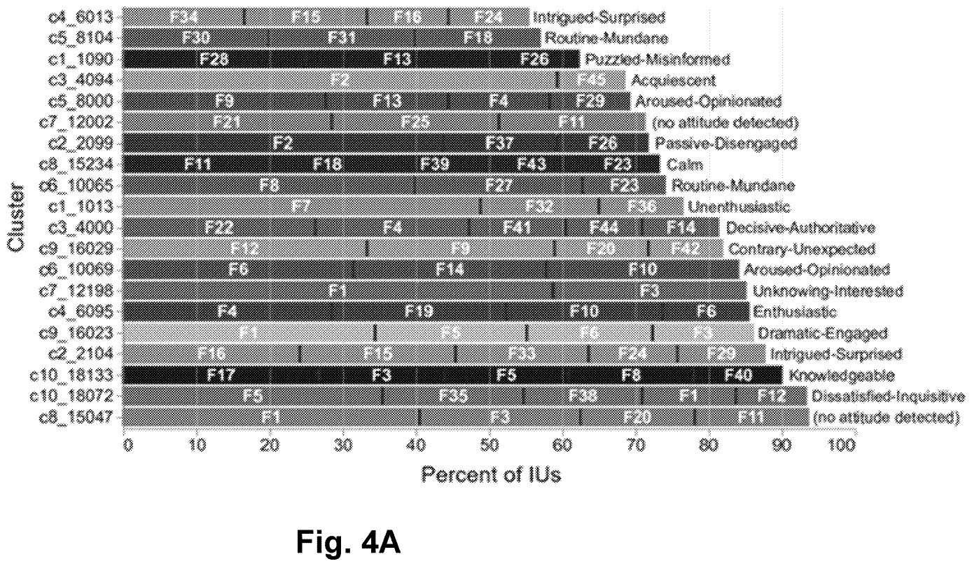

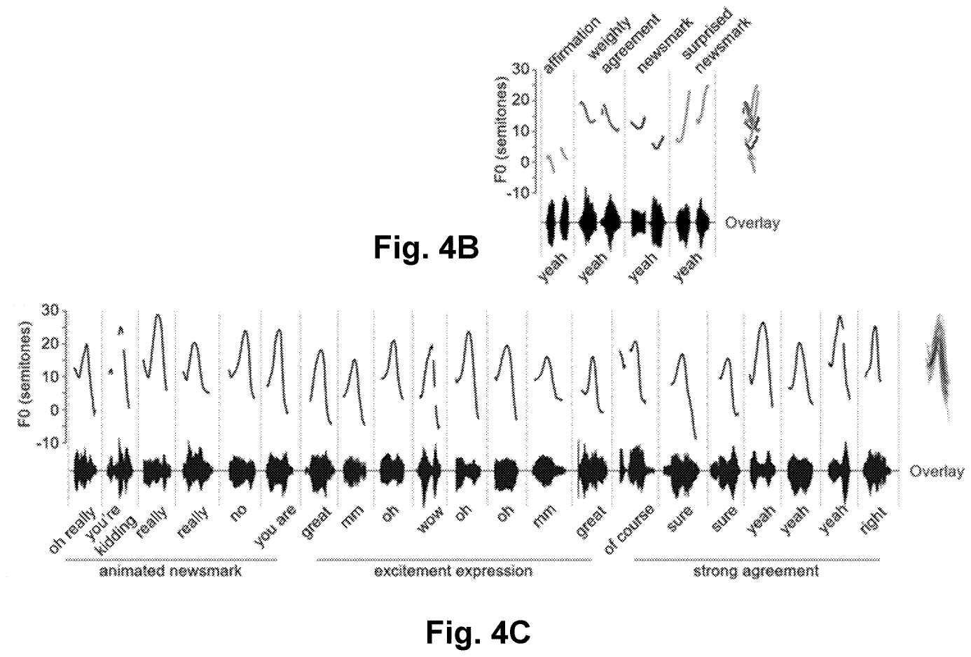

According to some embodiments a meaningful clustering of prosodic patterns should group together IUs that exhibit a functional common denominator, associated with at least one of the interactional functions achieved through prosody. A functional analysis of the CH dataset is summarized in FIGS. 4A, 4B and 4C. Within the random sample of 20 clusters described above, 78%+3 of the “correct prosody” IUs exhibit a recurring function (elaborated in the Methods section) (mean±SE). Importantly, all examined clusters exhibit multiple recurring functions, ranging between 2 to 5, as demonstrated in FIG. 4A. This functional polysemy, i.e., a single prosodic pattern fulfilling more than one linguistic function, is a significant observation. It is consistent with claims for the context-sensitive nature of prosody and its interrelatedness with lexis and syntax.

According to some embodiments, a post hoc control for text can reveal functional distinctions cued solely by prosody. As demonstrated for example in FIG. 4B eight responsive IUs are presented, consisting only of the word ‘yeah’, taken from four different clusters. A mid-range small pitch fall (cluster c1_1013) accomplishes the function of simple affirmation; A mid-high-range small pitch rise followed by a large fall (cluster c3_4000) accomplishes the function of weighty agreement, i.e., with a preceding statement, which is somewhat sensitive; A mid-range small pitch rise (cluster c2_2099) accomplishes the function of newsmarking (60), i.e., acknowledging the reception of new information; Finally, a high-range large pitch rise (c2_2104) functions as a surprised newsmark, i.e., in signaling the reception of new information that counters expectations. At the same time, it is currently demonstrated that prosodic patterns can fulfill the same function when coupled with different segments of text. For example, IUs with texts other than ‘yeah’ from cluster c2_2104 accomplish the aforementioned function surprised newsmark. Examples include ‘no’, ‘really’, or partial repetitions such as ‘was it’ and ‘did it’.

FIG. 4C presents further support for the functional independence of prosody, according to some embodiments of the invention. Cluster c4_6095, which depicts a prosodic pattern characterized by a high-range and extremely large rise-fall pitch movement, exhibits three frequent recurring functions. The function strong agreement was expressed, inter alia, using ‘sure’, ‘yeah’, and ‘of course’; animated newsmark, evaluating received information as highly “remarkable”, was expressed, inter alia, using ‘oh really’, ‘you're kidding’, and ‘you are’; and expression of excitement, was performed, inter alia, using ‘mm’, ‘oh’, and ‘wow’. The full list of single-cluster functions, which were identified is presented in Table 5.

According to some embodiments different functions of a given cluster are often related by a broader meaning, viz., the attitude of the speaker, defined as shared by at least 50% of the cluster's IUs. Here, attitude refers collectively to displays of epistemic, affiliative, affective, and deontic stances. Of the examined clusters, 18 out of 20 (90%) exhibited an attitude. Thus attitude, as opposed to function, is less context sensitive, and relates more directly to prosody. In the case of cluster c4_6095 (FIG. 4C), 93% of IUs share the attitude enthusiastic. In general, the currently provided analysis supports the claim that dynamic prosody is indicative of the speaker's emotional involvement.

Taken together, these results demonstrate that clusters do not only group prosodically similar IUs, but are also characterized by identifiable linguistic functions.

### Markovian Dynamics of Prosodic Patterns

According to some embodiments, following insights into the vocabulary and semantics of IU-sized prosodic patterns their syntactic behavior is investigated. Examining the cluster association of consecutive IUs revealed an excess of recurring cluster pairs as compared to randomized data. In contrast, according to some embodiments, recurring cluster triplets and higher-level structures were exceedingly rare. It is noted that more than half of the speaker turns in the current data consist of only a single IU and that lengthy turns are somewhat rare in conversational English.

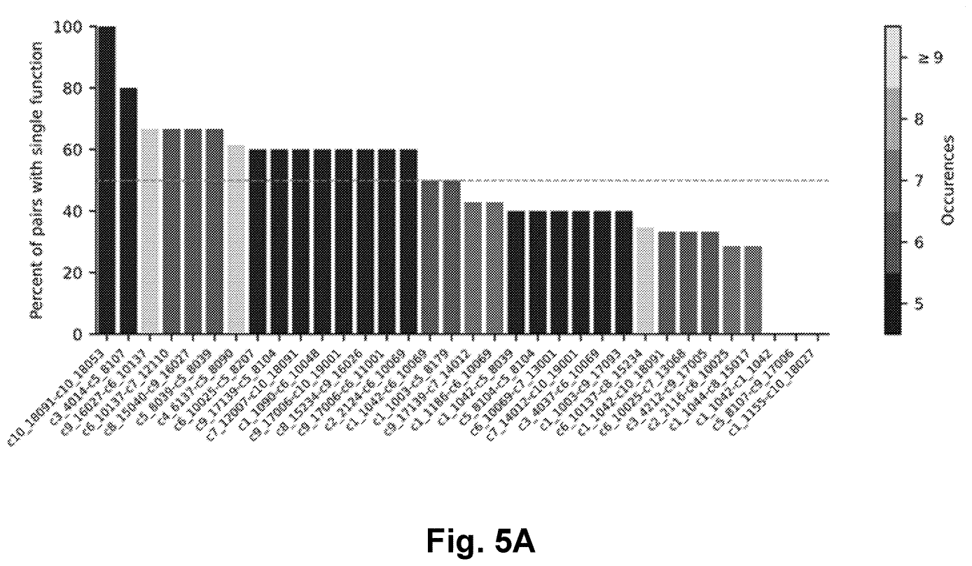

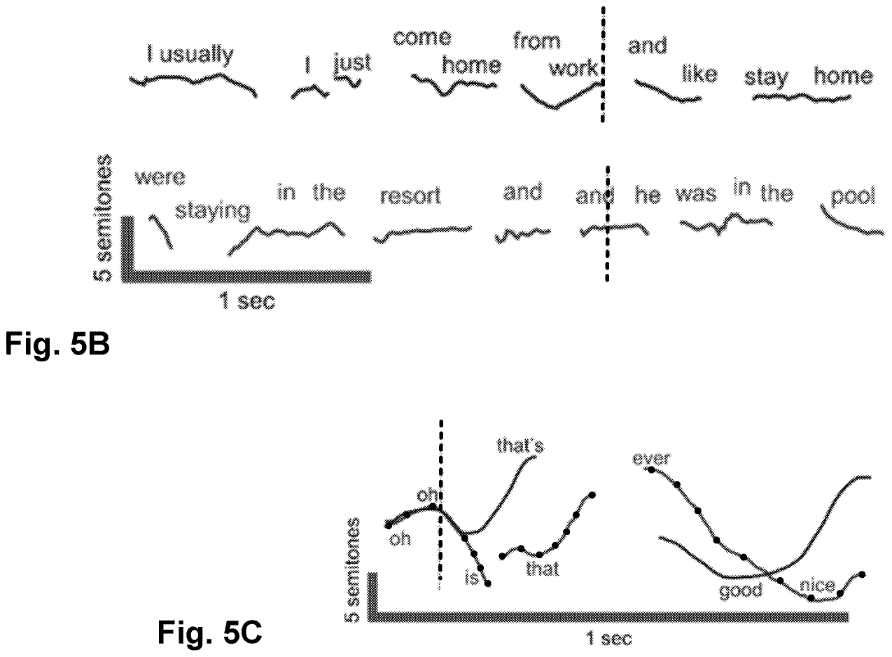

According to some embodiments, to explore whether common pairing of prosodic patterns could serve interactional needs, a functional analysis was applied to a sample of 34 recurrent cluster pairs (elaborated in the Methods section). In 17 of the 34 cluster pairs, a single linguistic function was shared by at least 50% of occurrences, as demonstrated in FIG. 5A. For comparison, only 2 of the 20 analyzed single clusters exhibited such functional uniformity, as demonstrated in FIG. 4A.

The two following examples demonstrate this effect, according to some embodiments of the invention. Cluster pair c9_16027-c6_10137, i.e., an IU from cluster c9_16027 immediately followed by an IU from cluster c6_10137, occurred twelve times. Both IUs are long and exhibit a flat pitch contour, slow speech rate and non-emphatic voice quality. Eight of these twelve occurrences share a distinct interactional function: reporting a habitual behavior or continuous state, often as background information. FIG. 5B shows the pitch contour and text of two representative cases, as demonstrated in Table 2; 1^{st} row for the 1^{st} example and 2^{nd} row for the 2^{nd} example.

TABLE 2
Text of the 12 occurrences of cluster pair c9_16027-c6_10137 (as demonstrated in FIG. 5B)
and their corresponding function. The IU pairs, at the eight top rows, share a distinct function.

| First IU | Second IU | Function |
|---|---|---|
| usually I just come home from work | and like stay home | habitual/continuous |
| were staying in the resort and | he was in the pool | habitual/continuous |
| you know during the time we just call | on a daily basis | habitual/continuous |
| you're ending one year and starting the | you know doing a lot | habitual/continuous |
| next year and | with the | |
| running through the | the um | habitual/continuous |
| you know everybody in the lobby you know | before leaving | habitual/continuous |
| president Sorenson was down hunting somewhere | down in Mexico or | habitual/continuous |
| but the trucks were very careful | which was um | habitual/continuous |
| from that one time I met her she's not very uh | uh | grounds for assessment |
| when she was talking to me and what I know | even more now | grounds for assessment |
| I mean like three weeks later it was like falling down | falling down off of her | disappointing fact |
| report so now you can uh | fill me in on yours | N/A (seg. error) |

Cluster pair c1_1042-c6_10069 occurred six times. It includes a combination of a short IU followed by a long one, both exhibit a high-range and extremely dynamic pitch contour. Three of these six occurrences function as a positive assessment given in response to informing. The first IU marks the reception of new information and the second provides the positive assessment. This exemplifies a well-defined conversational move accomplished by exactly two consecutive IUs. As in single clusters, as demonstrated in FIG. 4C Dynamic prosody signals the speakers ‘high emotive involvement. FIG. 5C shows the pitch contour and text of two representative cases, as shown in Table 3; shown with a line for the 1st example in the 1st row and a line with dots for the 2^{nd} example in the 2^{nd} row.

TABLE 3
Text of the 6 occurrences of cluster pair c1_{—}
1042-c6_10069 (as demonstrated in FIG. 5C) and their corresponding
function. The IU pairs at the three top rows share a distinct
function and the ones at the three bottom rows suffer from
either an F0 extraction error or a segmentation issue.

| First IU | Second IU | Function |
|---|---|---|
| oh | that's good | Responsive positive assessment |
| oh | is that ever nice | Responsive positive assessment |
| oh | that's great | Responsive positive assessment |
| that's | it's not | N/A (F0 extraction error) |
| well | one of the things | N/A (other's talk between IUs) |
| | Danny rice | |
| they | had to go yeah | N/A (segmentation error) |

According to some embodiments, the prevalence of recurring cluster pairs and the scarcity of higher-level structures suggest that the IU pair is a distinctive construct, regularly utilized in spontaneous conversation. The functional uniformity of cluster pairs and the identification of pairings, which serve single interactional functions suggest that the IU pair is a locus for reciprocal contextualization, resulting in a disambiguation of prosodic meaning.

### Statistical Analyses of Markovian Dynamics in Intonation Unit Sequences

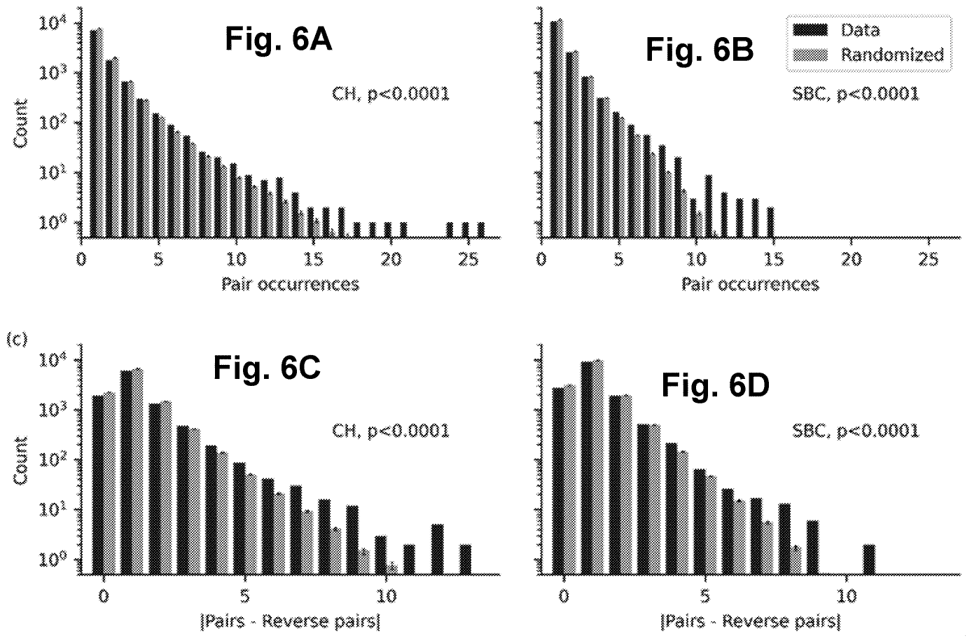

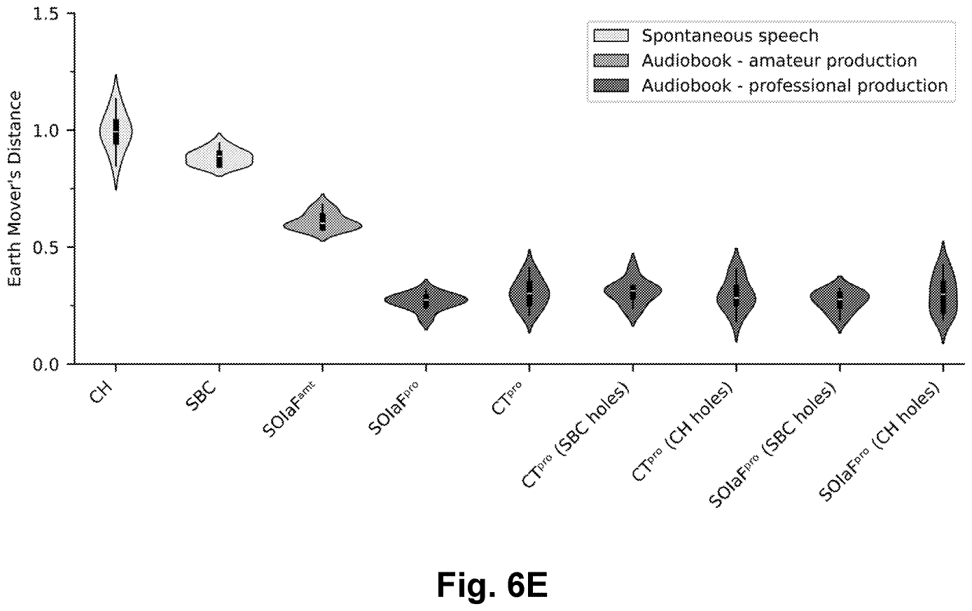

According to some embodiments, to quantitatively evaluate pairwise IU association, FIGS. 6A and 6B compare the observed distribution of the number of occurrences, for each cluster pair in the CH and SBC datasets (Blue) to a randomized sequence of IUs (Grey) with the same structure of speaker turns (elaborated in the Methods section). In both datasets a clear signature emerges—an excess of highly recurring cluster pairs in the actual data compared to the randomized sequence. According to some embodiments, using the Earth Mover's Distance (EMD)(67) as a measure of distance between the histograms, it is shown that the excesses in both datasets are statistically significant (p<0.0001, elaborated in the Methods section), and as demonstrate in FIG. 6E.

This statistical signature is distinct from and subtler than the cluster-pair functional uniformity identified by manual examination. For example, while cluster pairs occurring 5 times in the CH dataset show an excess of 19% compared to the corresponding random permutations (154 vs. 129 pairs), ~56% of them exhibit functional uniformity. According to some embodiments, manual analysis of ten cluster pairs with fewer occurrences (elaborated in the Methods section) assured that the effect of functional uniformity holds even when the excess of recurring pairs in real data as compared to randomized data is not statistically significant.

Consistent with the meaningful pairing of IU-sized prosodic patterns, real data differs from randomized data also in within-pair ordering. FIGS. 6C and 6D demonstrate the distribution of absolute differences between the number of instances of cluster pairs (cluster i followed by cluster j) and of their reverse pairs (cluster j followed by cluster i). According to some embodiments, the differences between the actual (dark gray) and randomized data (light gray) are statistically significant (p<0.0001, elaborated in the Methods section). According to some embodiments, given the differences between spontaneous and scripted speech (see Discussion), it is hypothesized that IU pairwise association may also differ according to data type. To address this question, the same statistical analysis was applied to two professionally produced audiobooks, and to an amateur production of one of them (elaborated in the Methods section). FIG. 6E summarizes this analysis. Both of the professionally produced audiobooks exhibited cluster-pair occurrence distributions that were similar to their corresponding randomized sequences. Importantly, excluding IUs corresponding to “holes” in the spontaneous speech datasets (created by speaker changes and unanalyzable IUs) did not significantly affect the corresponding EMDs. Interestingly, the amateur audiobook production yielded intermediate statistics, significantly below both spontaneous datasets but significantly above both professional audiobooks. These results support the notion that rehearsals and adherence to written text alter the prosodic patterning of IUs in a measurable manner, according to some embodiment of the invention.

According to some embodiments, the functional uniformity of cluster pairs (shown in the previous section) along with the pairwise associations of IUs suggest that prosodic patterns in spontaneous speech follow a basic Markovian syntax: the probability of a particular pattern to appear depends on the preceding one.

According to some embodiments of the invention, language functions as a structured system of communication in which signs or symbols convey meaning. According to some embodiments, these building blocks constitute the vocabulary while syntax and grammar provide the rules for combining them into coherent expressions. The currently provided model and methods are configured to identify building blocks represented by centroid pitch contours and define them as the conceptual elements of the prosodic vocabulary, according to some embodiments of the invention. To further illustrate, consider the dictionary entry “chair.” It is an idealized concept, representing all instances of chairs. Similarly, the currently provided methods construct a prosodic “dictionary entry” by grouping instances of similar prosodic patterns and distilling a single representative form; akin to representing multiple real-world occurrences by the word “chair”.

The currently provided model and methods provide empirical evidence for the existence of a finite vocabulary of prosodic patterns at the IU scale, according to some embodiments of the invention. Different English datasets yielded 200-350 clusters of pitch contours. These values were stable to variations in the clustering technique and hyperparameter settings. In all datasets, more than 90% of IUs were successfully clustered, and, as expected, the resulting clusters show an inverse correlation between prosodic markedness and cluster size.

The currently reported cluster numbers are not exact, likely due to the impromptu and inexact nature of conversational prosody and to noise that is intrinsic to it. The results are interpreted as an order-of-magnitude estimate of 200 (within a factor of 2) distinct prosodic patterns. In contrast to previous studies, a predetermined set of constituents or specific positions within the IU that they may occupy are not assumed. Nevertheless, the internal structure of the current a posteriori patterns can be systematically described using such frameworks. Additionally, a hierarchical similarity between our prosodic patterns was identified, which depends both on the internal structure and the register.

Semantically, identified prosodic patterns serve multiple functions but generally convey a broad attitude, according to some embodiments of the invention. Many of the identified functions are characteristic of talk-in-interaction-responsive in nature (as in FIGS. 2b-c, 3c) or inviting a response. A specific function is a result of a combination of prosody and text within a specific sequential position. Thus, the currently provided model and methods demonstrate one-to-many form-function relations, as the algorithm ignores text and context. However, according to some embodiments, speaker attitude depends more directly on prosody, and can be shared across IUs with different functions. Indeed, 90% of the manually analyzed clusters were associated with a distinct attitude.

According to some embodiments, IUs follow a Markovian-like structure, where a pattern's occurrence depends mainly on the preceding one. This demonstrates a linguistic theory, emphasizing the IU's centrality in spoken language. First, theory suggests that completed IUs can be of two kinds: “substantive”, i.e., conveying ideas of events, states, or referents, or “regulatory”, which coincide to a large extent with Discourse Markers. Identified cluster pairs often combine a short regulatory IU with a longer substantive one, forming a full conversational move (as in FIG. 5C). Second, substantive IUs adhere to a “one-new-idea” constraint. Thus, information which is easily packed in one written sentence, for example a basic grammatical nexus including a subject and a finite verb, often occupies an IU pair in spontaneous speech.

According to some embodiments, frequently occurring triplets of IUs are not present. This does not mean that longer strings of IUs are never utilized or have linguistic meaning. For example, list constructions may include a concatenation of three IUs or more. However, such patterns are overall rare and do not readily appear in the current analysis.

Despite the ubiquity and functional uniformity of IU-pairs, the currently provided analysis supports treating the IU, not the IU-pair, as the core unit of prosodic vocabulary. For one, over 50% of speaker turns in the current conversational data consists of a single IU. IUs that appear in such singleton turns cluster well and appear in all clusters. Additionally, a prosodic pattern associated with a given cluster can appear in several pair combinations and can occupy either one of the two positions in a pair (as demonstrated in FIG. 5A). These observations suggest that the meaningful pairing of IUs is evidence of a simple syntax.

According to some embodiments, scripted (or read) speech is the basis for much of spoken language research and/or models. However, according to some embodiments, scripted speech is based on written forms, and thus pre-planned and often rehearsed. It tends to be polished, stylized, and grammatically regular. In contrast, according to some embodiments, talk-in-interaction is colloquial and produced on-the-fly. It is typically beset with repairs and other types of discourse deviations, exhibiting “emergent” and flexible grammar. Furthermore, according to some embodiments, scripted speech is typically monologic and acted, while spontaneous conversation requires coordination between participants and carries social consequences. These discrepancies imply formal and functional differences in prosodic design which are not yet fully understood. According to some embodiments, comparing these data types showed that the statistical signature of cluster pairwise correlation in spontaneous speech was reduced in scripted speech (as demonstrated in FIG. 6E). This measurable difference and the unique functions of talk-in-interaction support using spontaneous conversation data in spoken language research and/or models.

The currently provided description of prosodic behavior in communication is not a foregone conclusion. According to some embodiments, a typical speaker utters thousands of IUs daily across various conversations, using thousands of words. Yet, according to some embodiments, their prosody largely draws from just a few hundred patterns, meaning that conversational English's prosodic vocabulary is far smaller than its theoretical limit.

According to some embodiments, conversational messaging can be variable or imprecise, yet according to some embodiments, the current vocabulary choices demonstrate regularity and meaning. They convey attitude and enhance linguistic function. According to some embodiments, as elements strung together, prosodic memory extends only to the previous IU. Unlike a composer envisioning an entire tune, just two units are planned ahead, spanning only a few seconds.

### Limitations and Future Work

The currently provided models and methods are configured for understanding noise and its sources. Conversational data presents challenges beyond technical issues like background noise and recording quality. Intrinsic noise arises because humans are not “perfect prosody machines,” leading to IU truncation from self-repair, overlapping speech, poor articulation, or inattentiveness. This creates correctly segmented IUs that cannot be meaningfully grouped, partly explaining currently observed silhouette scores. Human listeners use context to recognize transitional or incomplete IUs, while the automated analysis did not. As a result, intrinsic noise was prominent in the 11±1% of IUs that were correctly assigned to clusters but did not exhibit a linguistic function (as demonstrated in FIG. 4A). Since technology cannot eliminate this noise, understanding its frequency and impact is crucial for improving natural language processing and human-machine interactions.

The currently provided models and methods are configured for curating larger, higher-quality datasets for robust analysis. A clean, sizable dataset may enable generalizability, predicting the cluster of unseen IUs. The CH-SBC dataset suggests some generalizability already. A definitive vocabulary set can support a data-driven prosodic dictionary mapping prosodic patterns to their conversational functions in English.

The currently provided models and methods are configured to incorporate text and context into a comprehensive model that can disambiguate prosodic meaning and directly associate an IU with its interactional functions.

The methodology provided here can be applicable for exploring the structure of prosody in additional languages, cultural contexts, or social settings. For instance, the current methodology can be used to characterize elements of language acquisition during normal or atypical development, effects of conditions related to aging on speech, or speech within various institutional settings such as emergency calls, courtroom questioning, or classroom discourse. This incentivizes the construction of specialized yet extensive databases.

The currently provided models and methods are configured for unsupervised analysis of large datasets of spontaneous speech combined with manual sampling of the results identified signs of vocabulary, semantics, and syntax in the use of prosody on the IU scale. According to some embodiments, IUs can be meaningfully clustered based on their duration and the shape of their pitch curve and its register, i.e., its relative height normalized per speaker. As demonstrated, the results yield an order of magnitude of 200 (within the factor of 2) distinct prosodic patterns. A given IU-sized prosodic pattern typically exhibits several context-sensitive interactional functions, and a broader meaning, viz. speaker's attitude. According to some embodiments, sequences of two IUs, but typically not longer, are frequently utilized by speakers to accomplish distinct compound functions, a behavior that is more characteristic of spontaneous speech.

### Methods

### Datasets

According to some embodiments of the invention the CallHome corpus (labeled CH) (A. Canavan, D. Graff, G. Zipperlen, CALLHOME American English Speech. LDC97S42 (Preprint) (1997)) and the Santa Barbara Corpus of Spoken American English (labeled SBC) (J. W. Du Bois, et al., Santa Barbara corpus of spoken American English. (Preprint) (2005)) were analyzed. These corpora document spontaneous speech produced by a diverse group of speakers, and in a variety of linguistic contexts and communicative situations. Both datasets are widely used in research on- and/or models for-prosody in spoken communication, speech perception, and spoken language processing. The CH corpus consists of 120 unscripted dyadic telephone conversations between native speakers of American English. From each conversation, a contiguous 5- or 10-minute segment is manually transcribed. The SBC consists of 60 audio files that record spontaneous speech of various genres, from multi-party kitchen conversations and couples ‘dialogues to child tutoring, guided tours, sermons and university classes. A transcript accompanies each speech file, where manually identified intonation units are time stamped. For means of validation we also analyzed a joined version of CH and SBC, labeled CH-SBC. For scripted speech, two professionally produced audiobooks were analyzed: “Edge of Eternity”, the third book of the “Century Trilogy” by Ken Follett, read by John Lee (text: (K. Follett, Edge of Eternity (Penguin Books, 2014)), audio: (K. Follett, Edge of Eternity (Downpour, 2014))) (CT^{pro}) and “A Dance with Dragons”, the fifth book of the series “A Song of Ice and Fire” by George R. R. Martin, read by Roy Dotrice (text: (91), audio: (92)) (SOIaF^{pro}). In addition, an amateur production of “A Dance with Dragons” read by @DavidReadsASolaF (A Dance with Dragons. (2021). Available at: https://www.youtube.com/playlist?list=PLMLTM7CoBZvJqZfq8fTdfVohvoPnh98ve (Accessed 1 Sep. 2022)) (SOIaF^{amt}) was analyzed. Table 4 specifies the size of these datasets.

TABLE 4
The number of words and IUs, total recording time,
and segmentation type of the five datasets.

| | | | Number | Total | |
|---|---|---|---|---|---|
| | | Total | of IUs | recording | |
| | Number | number | (eligible for | duration | Type of |
| Source | of words | of IUs | analysis) | (~hours) | segmentation |
| CH | 242,622 | 47,764 | 43,086 | 20 | Automatic |
| SBC | 249,445 | 70,069 | 39,509 | 23 | Manual |
| CT^{pro} | 368,490 | 61,631 | 52,687 | 37 | Automatic |
| SOIaF^{pro} | 416,474 | 81,886 | 74,257 | 49 | Automatic |
| SOIaF^{amt} | 416,537 | 69,912 | 58,515 | 49 | Automatic |

### Alignment & Segmentation

According to some embodiments, prior to clustering, speech was segmented into IUs. The SBC was manually segmented previously. CH, CT^{pro}, SOIaF^{pro}, and SOIaF^{amt} were segmented using previously published automatic segmentation method (T. Biron, et al., Automatic detection of prosodic boundaries in spontaneous speech. PLOS One 16, e0250969 (2021)). In brief, the speech was first automatically aligned at the phone level using the Montreal Forced Alignment (MFA). Speech was then segmented at inter-word pauses of at least 0.3s, and then further segmented at inter-word points, where the mean phone duration decreases by at least 80%. The mean phone duration is calculated from the 0.3 s preceding the end of each word. In sum, the segmentation method relies on modulations in speech timing (slowing down and stopping) which are considered to be the most reliable cues for IU boundaries.

### Feature Extraction

According to some embodiments, speech pitch and intensity were extracted from source audio using the parselmouth interface to the Praat software package. The pitch was extracted at 100 samples/s. The intensity was extracted at 125 samples/s and then interpolated to 100 samples/s to match the pitch.

According to some embodiments, pitch was converted from Hertz to a semitone scale, which is closer to human perception of pitch. The pitch was then speaker-normalized by subtracting the median pitch of the specific speaker, as calculated over the entire dataset.

### Calculating Pitch Dynamics

According to some embodiments, for each cluster a measure of pitch dynamics was calculated to quantitatively estimate prosodic markedness. This measure was calculated based on the mean pitch contour of the cluster. It is defined as the product of pitch change, i.e., the min-max range of the pitch contour, and the pitch register, i.e., the absolute value of the average deviation of the pitch contour from the speaker's median.

### Filtering

According to some embodiments, IUs containing under 5 samples of defined pitch, IUs over 3 seconds in duration, and IUs with no words were excluded from the dataset prior to processing. Note that non-lexical elements (e.g., oh, wow, and m-hm) are considered “words”, and IUs consisting only of such elements were not filtered out. In the SBC dataset, where word level manual annotations are available, also removed were IUs which were marked as containing environmental noise, overlapping speech of multiple speakers, unknown speakers, unintelligible speech, and whispers. Whispers and overlapping speech were removed only if over a third of the words in the IU were marked as such.

Splitting Data into Deciles

According to some embodiments, the IUs were split into 10 equally sized groups (“deciles”), such that each decile contains IUs of similar durations. The entire analysis, including data preparation, autoencoder training and the subsequent clustering, is applied to each of these deciles separately.

### Low Dimensional Data Representation-Input Data Preparation

According to some embodiments, for each IU, sample points where pitch is undefined are linearly interpolated. The pitch is then smoothed using a weighted moving average with a 10-point sample-window length. The weights used for averaging are the intensity at each sample point, normalized to a (0, 1) scale within each IU. The resulting pitch vectors are then resampled to a common length according to the median length of the IUs in the decile, at 100 samples per second. Thus, for the shortest decile across the analyzed datasets a length of 12 points per IU was used, and for the longest 271.

### Low Dimensional Data Representation-Autoencoder (AE) Architecture

According to some embodiments, a multilayer AE network (101) was trained on the IU pitch vectors in order to create the lower-dimensional latent space in which the clustering of these vectors was provided in a following process.

The AE network layer architecture is shown schematically in FIG. 3A, according to some embodiments of the invention. The layers (and layer sizes in parentheses) were: input (100/s), dropout, hidden (100), dropout, hidden (50), latent (8), hidden (50), hidden (100), output (100/s). The hidden and latent layers are fully connected layers that use the Scaled Exponential Linear Unit (SELU) activation function. The output layer is a fully connected layer with no activation function. Dropout layers were used to prevent overfitting, with each dropout layer zeroing out 20% of its input.

The Keras software package was used to construct and train the AE. Training was done with the following hyperparameters: 1000 training epochs with data shuffling, a batch size of 500, a train-test split of 80-20%, the mean-squared-error loss function, and the Adam optimizer.

According to some embodiments, in addition, the Sliced-Wasserstein (SW) technique (106) was used to impose an approximate distribution on the vectors in the latent space. In the current case, a uniform distribution was chosen over a “thick walled spherical shell”, defined as 0.95∥x̅∥<1, where x̅ is the eight-dimensional latent vector. For each training batch, 50 random slices were sampled, and the SW loss component was added with a weight of 100 to the overall loss of the AE.

### Clustering

According to some embodiments, after training the AE, it was used to encode all of the IUs (in the decile), i.e., to find the eight-dimensional vector corresponding to each IU in the latent space of the trained AE. Clusters of IUs were then identified in this latent space.

According to some embodiments, clustering was done using the variational Bayesian Gaussian mixture model implemented by the scikit-learn software package. The following parameters were used for clustering: 1000 maximum iterations, 300 mixture components, and a weight-concentration-prior of 1/300. If there is a failure to converge, the clustering process is repeated up to 3 times with different random seeds.

According to some embodiments, clusters containing less than 1% of the IUs in the decile are considered invalid. All the IUs in these invalid clusters are taken (without the valid IUs) and passed again through the process of AE training and clustering from scratch. This process is repeated until there are no additional valid clusters found, or until there are less than 600 IUs remaining in invalid clusters. The 1% threshold limits the minimal size of a cluster and the maximum number of clusters in each decile. The number of clusters which were identified remained well below this limit.

### Silhouette Scores

According to some embodiments, Silhouette scores were generated using the scikit-learn software package (F. Pedregosa, et al., Scikit-learn: Machine Learning in Python. Journal of Machine Learning Research 12, 2825-2830 (2011)). Scores were calculated for each IU, then averaged into a score for each cluster (from all the deciles analyzed), and then averaged to get an overall score for the entire dataset.

### Cluster and Cluster-Pair Manual Evaluation

According to some embodiments, manual evaluation of clusters and cluster-pairs was performed on the primary run of the CH dataset with the aim of assessing the prosodic resemblance of IUs within clusters and their functional uniformity.

### Cluster Prosodic Resemblance

According to some embodiments, first, a visualization of the extracted FO contours of all IUs in each of the clusters was examined. Clusters that include a majority of IUs with severe extraction errors were identified. This resulted in a categorization of clusters to “real” clusters and “noise” clusters.

Second, each decile was randomly sampled to obtain a representative sample of 20 “real” clusters. The stratified sampling scheme (where the strata are the duration deciles) aimed at revealing prevalent trends or systematic problems. Clusters in the sample were of varying sizes, ranging from 56 to 647 IUs (in total n=3484 IUs). The sampled clusters were manually analyzed by repeated listening supported by acoustic analysis. The goals were to determine the degree to which the units in a given cluster adhere to a common prosodic pattern and to validate the automatic segmentation to IUs and the extraction of FO. This analysis provided a four-way categorization of IUs within a single cluster: “correct prosody”—the IU matches the prosodic pattern of the cluster; “incorrect prosody”—the IU does not match the cluster prosody; “segmentation error”—the segment of speech is not a valid IU; and “FO extraction error”—the IU was assigned to the cluster due to an FO extraction error.

### Cluster Function and Attitude

According to some embodiments, the third step included a functional analysis of the same 20 clusters. From each cluster, a sample of 50 IUs was examined in its conversational context, in a search for recurring functions. According to some embodiments, a function was required to be observed at least 3 times in the 50 IUs sample for the observation to be considered non-coincidental. According to some embodiments, in clusters with more than 35 “correct prosody” IUs, a function was required to occur at least four times in order to be considered recurring.

Additionally, according to some embodiments, when possible, clusters were labeled for the speaker's attitude. Attitude is taken here as a broader linguistic meaning than function, referring collectively to displays of epistemic, affiliative, affective, and deontic stances. According to some embodiments, a cluster was assigned an attitude only when at least 50% of its IUs share it.

According to some embodiments, rather than assuming a closed set of predetermined categories, an open-ended set of functions and attitudes was allowed. This is consistent with current approaches to the study of spoken language, which advocate a data-driven delineation of linguistic categories.

TABLE 5
Labels of single-cluster function resulted from manual
analysis of 20 clusters from the CH dataset.

| | | Ex. identifier | | |
|---|---|---|---|---|
| Function | Example | (file_sec.) | Cluster/s | % |
| 1. yes-no question* | have you heard from | 4065_890.91 | c7_12198, | 8.6% |
| | Ron and Doris | | c8_15047, | |
| | | | c9_16023, | |
| | | | c10_18072 | |
| 2. continuer* | m-hm | 6217_438.77 | c2_2099, | 6.0% |
| | | | c3_4094 | |
| 3. strong/dramatic | believe it or not | 4792_327.57 | c7_12198, | 4.9% |
| statement | he's an he's an | | c8_15047, | |
| | English teacher | | c9_16023, | |
| | now | | c10_18133 | |
| 4. strong/weighty | of course | 6217_581.59 | c3_4000, | 4.6% |
| agreement* | | | c4_6095, | |
| | | | c5_8000, | |
| 5. complaint | called her | 4629_206.74 | c9_16023, | 4.4% |
| | yesterday and there | | c10_18072, | |
| | was no answer | | c10_18133 | |
| 6. contrary to previous | no that was when | 4887_254.58 | c4_6095, | 4.0% |
| | she | | c6_10069, | |
| | | | c9_16023 | |
| 7. affirmation/ | yeah | 5713_693.89 | c1_1013 | 3.8% |
| agreement* | | | | |
| 8. transition to | and then we'll | 4431_499.63 | c6_10065, | 3.8% |
| predication | | | c10_18133 | |
| 9. contrastive statement | it's not dangerous | 4844_709.91 | c5_8000, | 3.6% |
| | it's dangerous if | | c9_16029 | |
| | you're losing | | | |
| | weight | | | |
| 10. expression of | wow | 4072_50.64 | c4_6095, | 3.5% |
| excitement* | | | c6_10069 | |
| 11. list item | I like the music | 4522_514.56 | c7_12002, | 3.5% |
| | | | c8_15047, | |
| | | | c8_15234 | |
| 12. surprising statement | she's actually | 4838_836.31 | c9_16029, | 2.9% |
| | going to college | | c10_18072 | |
| | to be an opera | | | |
| | singer | | | |
| 13. expression of | oh | 5273_437.83 | c1_1090, | 2.6% |
| surprise* | | | c5_8000 | |
| 14. strong assessment | it's very cultural | 5273_554.39 | c3_4000, | 2.6% |
| | | | c6_10069 | |
| 15. surprised newsmark* | did it | 6252_300.72 | c2_2104, | 2.4% |
| | | | c4_6013 | |
| 16. enthusiastic | m-hm | 4580_335.72 | c2_2104, | 2.2% |
| continuer* | | | c4_6013 | |
| 17. critical statement | but see it's just | 0638_778.1 | c10_18133 | 2.0% |
| | like her the last | | | |
| | minute be too lazy | | | |
| 18. expression of empathy* | I know I know | 4556_473.66 | c5_8104, | 2.0% |
| | | | c8_15234 | |
| 19. animated newsmark* | you're kidding | 5713_478.8 | c4_6095 | 1.8% |
| 20. basis for dramatic | by the time you've | 5373_636.86 | c8_15047, | 1.8% |
| statement | been pregnant for | | c9_16029 | |
| 21. reported speech/ | well do you think | 4926_1091.2 | c7_12002 | 1.8% |
| behavior | this is pajamas | | | |
| 22. weighty acknowledgement* | oh | 4431_48.8 | c3_4000 | 1.8% |
| 23. conclusive remark | it was so official | 6045_378.68 | c6_10065, | 1.5% |
| | | | c8_15234 | |
| 24. initiating dispreferred | well | 6045_230.24 | c2_2104, | 1.5% |
| response* | | | c4_6013 | |
| 25. hesitant transition to | one is um | 4808_848.08 | c7_12002 | 1.5% |
| predication | | | | |
| 26. newsmark* | yeah | 4875_592.26 | c1_1090, | 1.5% |
| | | | c2_2099 | |
| 27. recycled move | you're not into | 4595_412.68 | c6_10065 | 1.5% |
| | that | | | |
| 28. repair initiation* | huh | 4580_723.61 | c1_1090 | 1.5% |
| 29. topic/frame shift | like Clair | 6474_256.14 | c5_8000 | 1.5% |
| 30. agreeing 2nd | that's too weird | 4822_785.81 | c5_8104 | 1.3% |
| assessment* | | | | |
| 31. filler/placeholder | and um | 4822_796.87 | c5_8104 | 1.3% |
| 32. logical conjunction | so | 4431_125.96 | c1_1013 | 1.3% |
| 33. astonished repair | what | 6861_854.43 | c2_2104 | 1.1% |
| initiation* | | | | |
| 34. surprised question* | in Madrid | 4157_493.32 | c4_6013 | 1.1% |
| 35. uptalk | I looked into a | 4807_612.8 | c10_18072 | 1.1% |
| | masters program | | | |
| | here | | | |
| 36. acknowledgement* | good | 5046_266.92 | c1_1013 | 0.9% |
| 37. expression of mild | oh | 5532_525.52 | c2_2099 | 0.9% |
| surprise* | | | | |
| 38. intensification | especially if it's | 4112_247.31 | c10_18072 | 0.9% |
| | just the few days | | | |
| | before | | | |
| 39. presenting reported | in his BMW and | 4838_468.54 | c8_15234, | 0.9% |
| speech | he's like | | c8_15047 | |
| 40. rough estimation | like fifteen | 4093_1529.38 | c10_18133 | 0.9% |
| | thousand or | | | |
| | whatever here | | | |
| 41. weighty logical | because | 5872_831.67 | c3_4000 | 0.9% |
| conjunction | | | | |
| 42. contrastive question* | would you rather | 4753_821.91 | c9_16029 | 0.7% |
| | have a doctor who | | | |
| | tells you not to eat | | | |
| 43. parenthesis | just writing this | 4245_496.15 | c8_15234 | 0.7% |
| | down so I | | | |
| 44. repeat | Danny | 6314_593.62 | c3_4000 | 0.7% |
| 45. reluctant agreement* | maybe | 6100_1331.91 | c3_4094 | 0.5% |

For each function, the table includes an example, the cluster/s exhibiting the function, and the function relative frequency;
*asterisks indicate functions which are by definition interactional, responsive or inviting a response.

According to some embodiments, the current notion of attitude is related to emotion. Psychological theory has suggested more than a dozen different sets of basic emotions, each one includes between 2 and 11 labels. Most familiar are the set of six emotions, commonly used in speech emotion recognition studies, and that of eight emotions.

Such basic taxonomies were often found to be insufficient for describing actual data, and analysts expanded and refined them or, like the current methods, allowed for an open-ended set of labels. According to some embodiments, given the current broad definition of attitude (see above), attitude labels can be related to other known domains, such as the politeness-rudeness continuum and the epistemic gradient.

### Cluster Pair Function

According to some embodiments, a functional analysis of cluster pairs was performed independently of the results of the single clusters functional analysis. A sample of 34 cluster pairs, was analyzed, which collectively included 225 IU pairs. This sample included cluster pairings with at least five occurrences (ranging between 5 and 26, mean of 6.6, standard deviation 3.8) and exhibited the highest occurrence rate, after normalizing for cluster size (cluster sizes range between 91 and 916, mean of 334, standard deviation 201). The reason to focus on cluster pairs of at least five occurrences, despite comprising only a small fraction of the data, as demonstrated in FIG. 6A, was that the current functional analysis relies on the identification of recurring phenomena. According to some embodiments, for means of validation, however, an additional sample of 10 cluster pairs was examined. The validation sample included five pairs with three occurrences and five with four occurrences.

### Randomized Assignment of IUs to Clusters

According to some embodiments, randomized data sets were generated by randomly permuting the cluster ID labels of the corresponding dataset. Thus, label i appeared Si times, where Si was the size of the i^{th} cluster and locations with missing data and/or speaker changes were preserved. According to some embodiments, pairs (or triplets, quadruplets etc.) of IUs were then counted in a randomized sequence that resembled the original data in the frequencies of labels and in the positions of “holes” in the sequence. For each of the datasets, this procedure was repeated 100 times and the results were averaged to produce histograms.

### Statistical Tests

According to some embodiments, to compare the histograms as demonstrated in FIGS. 6A-6E, p-values were calculated as follows. The null and alternative hypotheses were concerned with IU pairs that appeared between 3 and 13 times (FIGS. 6A and 5B) or 3-9 times (FIGS. 6C and 6D). HO stated that the numbers of occurrences in the data were drawn from the same distributions as those for the randomized data. Alternatively, they were drawn in any order from distributions with higher means.

According to some embodiments, for each bin corresponding to ≥3 occurrences, the empirical distribution was calculated using 100 randomized sequences of clusters (see above) and a kernel-density estimate with Gaussian kernels. These empirical distributions were integrated to obtain the probability of a count at least as large as the observed one. The resulting probabilities were multiplied (counts in separate bins were only weakly correlated as the majority of pairs contributed to the first two bins in each histogram). Since the order of the counts was arbitrary, the probabilities were further multiplied by the factorial of the number of bins tested. The resulting p-value estimated the probability, under the null hypothesis, of observing counts at least as large as the data in any order.

According to some embodiments, to compare the means of the groups of EMDs as demonstrated in FIG. 6E, p-values were obtained using Tukey's range test (honestly significant difference, HSD). In brief, this test controls the family-wise error rate, i.e., the probability of making at least a single type I error (false positive), across multiple pairwise comparisons.

Neural networks (NN) or connectionist systems are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers.

NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

In practice, a NN, or NN learning, can be simulated by one or more computing nodes or cores, such as generic central processing units (CPUs, e.g. as embodied in personal computers) or graphics processing units (GPUs such as provided by Nvidia Corporation), which can be connected by a data network. A NN can be modelled as an abstract mathematical object and translated physically to CPU or GPU as for example a sequence of matrix operations where entries in the matrix represent neurons (e.g. artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of compute power, on the order of 10s or even 100s of Teraflops, or a large set of cores. On modern GPUs this can be done using 4,000-5,000 cores.

According to some embodiments, specific high-value implementations of the prosodic dictionary include at least one of the following applications:
the prosodic dictionary can be used to define a prosodic signature of any given speaker, which can serve for speaker identification and/or speaker verification purposes;
the prosodic dictionary can be configured to distinguish neurodivergent speakers from neurotypical speakers, a distinction that can be used as an aid for early diagnosis of various neurological conditions;
based on user characterization, derived from the prosodic signature, the prosodic dictionary can be used to identify deviations that originate from lying and deceit, thereby functioning as a component of a lie detection system;
the prosodic dictionary can be used to build a sentiment analysis and/or detection system that uses the dictionary to tag speaker IUs with attitude and underlying meaning, enabling automated emotional and attitudinal content analysis.

Different embodiments are disclosed herein. Features of certain embodiments may be combined with features of other embodiments; thus, certain embodiments may be combinations of features of multiple embodiments.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A computer implemented method for recognizing at least one of: prosodic-type and at least one prosodic-meaning, for a segment of an audio signal; the method comprising a step of:
applying a trained recognizing module on a representative vector, which is configured to represent the segment of the audio signal, to obtain an output of at least one of: prosodic-type and at least one prosodic-meaning;
thereby recognizing at least one of: the prosodic-type and the prosodic-meaning/s of the segment of an audio signal.

2. The method of claim 1, wherein the segment of the audio signal is one selected from: a word, a sentence, an intonation unit, a syllable, interpausal unit, speaker turn and any combination thereof.

3. The method of claim 1, wherein the recognizing module comprises: a trained opting module, configured to:
receive an input comprising the representative vector, and
output a prosodic-type for the representative vector, which is selected for being a closest prosodic-type to the representative vector, out of a group of predetermined prosodic-types; and wherein at least one of the following holds true:
each of the prosodic-types is associated with at least one prosodic-meaning;
each of the prosodic-types is represented by a prosodic-pattern, and wherein the recognizing module is further configured to output the representative prosodic-pattern of the selected prosodic-type.

4. The method of claim 3, wherein the trained opting module is trained via clustering, and the predetermined prosodic-types are predetermined prosodic-clusters.

5. The method of claim 4, further comprising a step of:
training the opting module, using a group of training representative vectors representing a group of training segments of audio-signals, to cluster the training representative vectors and provide the predetermined clusters, and further provide for each predetermined cluster its representative prosodic-pattern, calculated from its member representative vectors.

6. The method of claim 5, wherein the training of the opting module is unsupervised.

7. The method of claim 3, wherein the recognizing module further comprises: a trained associating module, configured to:
receive an input comprising the selected prosodic-type, from the group of predetermined prosodic-types, and
output the prosodic-meaning/s, selected from a group of predetermined prosodic-meanings.

8. The method of claim 7, further comprising a step of:
training the associating module to associate each of the predetermined prosodic-types with at least one prosodic-meaning, selected from the group of predetermined prosodic-meanings, using a 2^{nd} training-set comprising:
the group of predetermined prosodic-types and their representative prosodic-patterns; and
per each predetermined prosodic-type a group of its member representative vectors, and their represented segments of audio-signals.

9. The method of claim 8, wherein the step of training the associating module is supervised, and wherein the 2^{nd} training-set further comprises at least one of: known prosodic-meaning/s and extracted text, for at least some of the segments of audio-signals of the member representative vectors, in each of the predetermined prosodic-types.

10. The method of claim 9, wherein the 2^{nd} training set further comprises at least one of:
known prosodic-meaning/s, and
at least one of: extracted text for at least some of the segments of audio signals preceding, and following the member-representative-audio-signals in the source speech.

11. The method of claim 9, wherein the known prosodic-meaning are provided via at least one of:
a linguist interpretation;
adverbial dialog tags in a source speech of the representative audio signals; and
a use of a large language model (LLM); and
any combination thereof.

12. The method of claim 8, wherein the training of the associating module further comprises:
for each type, calculating a measure of pitch dynamics of its representative prosodic pattern, to quantitatively estimate prosodic markedness of each of the predetermined types.

13. The method of claim 1, wherein the method is implemented via a system comprising at least one of: a processor; memory; one or more code sets comprising instructions for performing the method, the code sets being stored in a memory and executed in a processor; a microphone, an input device, an output device, a display device and any combination thereof.

14. A computer implemented method for providing a prosodic dictionary for segments of audio signals, the method comprising a step of:
determining a representative vector for each of the segments of the audio signals; by extracting at least one acoustic feature selected from pitch, intensity, and speech-rate from each segment;
applying a classifying-module configured to classify the determined representative vector into a predetermined number of prosodic-types;
representing each of the prosodic-types via a prosodic-pattern; and
associating each of the prosodic-types with at least one prosodic-meaning.

15. The method of claim 14, wherein the segment of the audio signal is one selected from: a word, a sentence, an intonation unit, a syllable, interpausal unit, speaker turn and any combination thereof.

16. The method of claim 14, wherein each of the prosodic-patterns is determined by its member representative vector.

17. The method of claim 14, wherein the prosodic dictionary is configured to receive an input of a segment of an audio signal and output at least one of:
a prosodic-type for the input segment of an audio signal;
a prosodic-pattern for a prosodic-type for the input segment of an audio signal;
a prosodic-meaning for the input segment of an audio signal; and
any combination thereof.

18. The method of claim 14, further comprising using the prosodic dictionary for at least one of:
automated analysis of speech content;
at least one of: identification and generation of emotional speech;
building prosodic dictionaries for other languages;
comparative analysis of speech across cultural contexts;
at least one of: comparative analysis of speech across social and institutional settings;
at least one of: characterizing prosodic structure in specific social and institutional settings;
at least one of: prosodic guidance for improved performance in specific social and institutional settings;
diagnosis of the effect of aging on speech;
evaluation of development stages during language acquisition;
evaluation of the naturality of LLM speech outputs;
classification of discourse types by prosodic structure;
at least one of: identification of commercial and sponsored content in social media;
at least one of: identification and filtering of abusive content in social media; and
any combination thereof.

19. The method of claim 14, wherein the method is implemented via a system comprising at least one of: a processor; memory; one or more code sets comprising instructions for performing the method, the code sets being stored in a memory and executed in a processor; a microphone, an input device, an output device, a display device and any combination thereof.

20. A computer implemented method for recognizing at least one of: prosodic-type and at least one prosodic-meaning, for a segment of an audio signal; the method comprising:
determining, by at least one processor, a representative vector for the segment of the audio signal, by extracting at least one acoustic feature selected from: pitch, intensity, and speech-rate from the segment;
applying a trained recognizing module on the representative vector to obtain an output of at least one of: prosodic-type and at least one prosodic-meaning;
thereby recognizing at least one of: the prosodic-type and the prosodic-meaning for the segment of the audio signal.
